(19) United States
(12) Patent Application Publication
(10) Pub. No.: US 2026/0303601 A1
(43) Pub. Date: Oct. 1, 2026

(54) DOCUMENT-CONTROLLED REMOTE ACCESS MANAGEMENT

(71) Applicant: FACTIFY TECHNOLOGIES INC., Dover, DE (US)

(72) Inventors: Matan Gavish, Givat Ada (IL); Gil Asher, Binyamina (IL)

(21) Appl. No.: 19/568,354

(22) Filed: Mar. 16, 2026

Related U.S. Application Data
(63) Continuation of application No. PCT/US2025/033598, filed on Jun. 13, 2025.
(60) Provisional application No. 63/661,534, filed on Jun. 18, 2024.
(60) Provisional application No. 63/668,068, filed on Jul. 5, 2024.
(60) Provisional application No. 63/674,793, filed on Jul. 23, 2024.
(60) Provisional application No. 63/680,061, filed on Aug. 6, 2024.
(60) Provisional application No. 63/685,234, filed on Aug. 20, 2024.
(60) Provisional application No. 63/693,173, filed on Sep. 10, 2024.
(60) Provisional application No. 63/707,992, filed on Oct. 16, 2024.
(60) Provisional application No. 63/713,200, filed on Oct. 29, 2024.
(60) Provisional application No. 63/714,009, filed on Oct. 30, 2024.
(60) Provisional application No. 63/723,471, filed on Nov. 21, 2024.
(60) Provisional application No. 63/736,568, filed on Dec. 19, 2024.
(60) Provisional application No. 63/738,639, filed on Dec. 24, 2024.
(60) Provisional application No. 63/774,949, filed on Mar. 20, 2025.
(60) Provisional application No. 63/794,007, filed on Apr. 24, 2025.
(60) Provisional application No. 63/794,564, filed on Apr. 25, 2025.
(60) Provisional application No. 63/800,869, filed on May 6, 2025.
(60) Provisional application No. 63/822,629, filed on Jun. 12, 2025.
(60) Provisional application No. 63/925,068, filed on Nov. 25, 2025.
(60) Provisional application No. 63/943,892, filed on Dec. 18, 2025.
(60) Provisional application No. 63/944,143, filed on Dec. 18, 2025.
(60) Provisional application No. 63/962,034, filed on Jan. 16, 2026.

(51) Int. Cl. H04L 9/40

(52) U.S. Cl. CPC H04L 63/101; H04L 63/108; H04L 63/062

(57) ABSTRACT

The disclosed systems and methods relate to document-controlled remote access management. Some examples involve self-governing documents that autonomously manage access and interactions. These documents can maintain records of authorized entities, receive access requests from remote interfaces, and determine authorization using stored records. Upon verification, the document can either grant or deny access, providing security and compliance. Various other methods and systems are also disclosed.

### PRIORITY CLAIMS TO RELATED APPLICATIONS

This application is a continuation application of and claims priority to International Patent Application No. PCT/US25/33598 filed Jun. 13, 2025, which claims priority to U.S. Provisional Patent Application No. 63/661,534 filed Jun. 18, 2024, U.S. Provisional Patent Application 63/668,068 filed Jul. 5, 2024, U.S. Provisional Patent Application 63/674,793 filed Jul. 23, 2024, U.S. Provisional Patent Application 63/680,061 filed Aug. 6, 2024, U.S. Provisional Patent Application 63/685,234 filed Aug. 20, 2024, U.S. Provisional Patent Application 63/693,173 filed Sep. 10, 2024, U.S. Provisional Patent Application 63/707,992, filed Oct. 16, 2024, U.S. Provisional Patent Application 63/713,200, filed Oct. 29, 2024, U.S. Provisional Patent Application 63/714,009 filed Oct. 30, 2024, U.S. Provisional Patent Application 63/723,471 filed Nov. 21, 2024, U.S. Provisional Patent Application 63/736,568, filed Dec. 19, 2024, U.S. Provisional Patent Application 63/738,639, filed Dec. 24, 2024, U.S. Provisional Patent Application 63/774,949, filed Mar. 20, 2025, U.S. Provisional Patent Application 63/794,007, filed Apr. 24, 2025, U.S. Provisional Patent Application 63/794,564, filed Apr. 25, 2025, U.S. Provisional Patent Application 63/800,869, filed May 6, 2025, and U.S. Provisional Patent Application 63/822,629 filed Jun. 12, 2025, each of which this application claims benefit to and priority to, and each of which are incorporated herein in their entirety by these references. This application also claims priority to and benefit of U.S. Provisional Patent Application 63/925,068, filed Nov. 25, 2025, U.S. Provisional Patent Application 63/943,892, filed Dec. 12, 2025, U.S. Provisional Patent Application 63/944,143, filed Dec. 12, 2025, U.S. Provisional Patent Application 63/962,034, filed Jan. 16, 2026, and U.S. Provisional Patent Application 64/012,006, filed Mar. 10, 2026, each of which are incorporated herein in their entirety by these references.

### BACKGROUND

In the digital age, electronic documents have become the cornerstone of information exchange and communication across various industries. These documents, often stored in formats such as PDF, Word, or Excel, are typically shared and accessed through local, shared, or cloud-based systems. However, as these documents are distributed, the original owner frequently loses control over their access, modification, and distribution, leading to potential security risks and unauthorized dissemination. This lack of control is particularly concerning for organizations handling sensitive information, as they must rely on the goodwill of recipients and legal frameworks to ensure compliance with confidentiality agreements and data protection policies.

Traditional document management systems and access control mechanisms often fall short in providing comprehensive control and security. They typically offer pseudo-control through policies and procedures, which can be easily circumvented. Moreover, the proliferation of electronic documents across various platforms and devices exacerbates the challenge of maintaining a single, true version of a document, leading to issues with version control and data integrity. This creates a pressing need for a more robust system that enables document owners to maintain control over their documents, ensuring secure access and interaction while preventing unauthorized distribution and modification.

### SUMMARY

As will be described in greater detail below, the present disclosure describes a method including: maintaining, by a self-governing document, records identifying entities authorized access to at least portions of the self-governing document; receiving, at the self-governing document, a request from a remote interface to access the self-governing document; using, by the self-governing document, the records to determine whether the request from the remote interface is from an authorized entity; and in response to determining whether the request is from an authorized entity, performing one of: providing a response to the remote interface indicating access to the self-governing document is allowed; and providing a response to the remote interface indicating access to the self-governing document is not allowed.

In some aspects, the techniques described herein relate to a system including: one or more physical processors; and physical memory including computer-executable instructions that, when executed by the one or more physical processors, cause at least one of the one or more physical processors to: maintain, by a self-governing document, records identifying entities authorized access to at least portions of the self-governing document; receive, at the self-governing document, a request from a remote interface to access the self-governing document; use, by the self-governing document, the records to determine whether the request from the remote interface is from an authorized entity; and in response to determining whether the request is from an authorized entity, perform one of: providing a response to the remote interface indicating access to the self-governing document is allowed; and providing a response to the remote interface indicating access to the self-governing document is not allowed.

In some aspects, the techniques described herein relate to a non-transitory computer-readable medium including computer-executable instructions that, when executed by at least one of one or more physical processors of a computing device, cause the computing device to: maintain, by a self-governing document, records identifying entities authorized access to at least portions of the self-governing document; receive, at the self-governing document, a request from a remote interface to access the self-governing document; use, by the self-governing document, the records to determine whether the request from the remote interface is from an authorized entity; and in response to determining whether the request is from an authorized entity, perform one of: providing a response to the remote interface indicating access to the self-governing document is allowed; and providing a response to the remote interface indicating access to the self-governing document is not allowed.

These and other features will be more clearly understood from the following detailed description taken in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates a system designed for creating self-governing documents, showing various interfaces and components that facilitate document creation, communication, and access control.

FIG. 2 and the corresponding description present a networked document management system, highlighting the interaction between a computing device and a server through a network connection.

FIGS. 3-4 show flowcharts detailing methods of self-governing documents.

FIG. 5 illustrates the integration of security features within documents, such as cryptographic codes, to enhance protection and enable authentication and tracking.

FIGS. 6 and 7 depict methods for managing access rights via a self-governing document.

FIGS. 8-10 depict various interfaces for managing access rights via a self-governing document.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The traditional concept of electronic documents is deeply rooted in the paradigm arising out of the invention of the printing press by Johannes Gutenberg. For centuries, the printed document had been the cornerstone of information dissemination, and even as society transitioned into the digital age, the structure and functionality of documents remained largely unchanged. Electronic documents, such as PDFs and Word files, are essentially digital recreations of physical documents, designed to mimic the static, linear nature of their printed counterparts. However, this adherence to the Gutenberg paradigm has imposed unnecessary limitations on the potential of electronic documents, confining them to the same constraints as their physical predecessors. The transformation of electronic documents into smart documents with embedded intelligence represents an entirely new paradigm, one that breaks free from the constraints of the past and unlocks unprecedented possibilities in access control and document management.

At its core, the Gutenberg paradigm is characterized by the static nature of printed documents. Once a document is printed, it becomes a fixed entity, unable to adapt, evolve, or respond to its environment. This static nature was carried over into the digital realm, where electronic documents are often treated as static files that can be copied, shared, and accessed without any inherent control mechanisms. For example, when a PDF is emailed to a recipient, the sender loses all control over how the document is used, whether it is copied, forwarded, or printed. This lack of control is a direct consequence of the Gutenberg paradigm, which assumes that documents are passive objects, incapable of governing their own interactions.

The transformation of electronic documents into smart documents with embedded intelligence challenges this outdated paradigm and introduces a new way of thinking about documents. Smart documents are not merely digital recreations of physical documents; they are dynamic, autonomous entities capable of managing their own lifecycle, access permissions, and interactions. By embedding intelligence within the document itself, smart documents can operate independently within a digital ecosystem, offering significant improvements and new possibilities in access control.

One of the most transformative aspects of smart documents is their ability to enforce access control. For example, smart documents can adapt to changing circumstances by dynamically updating access permissions. For example, if an employee leaves a company, the smart document can immediately revoke their access, even if the document resides on the employee's personal device.

Another feature of smart documents is their ability to integrate advanced security measures, such as cryptographic watermarking and encrypted data transmission. Cryptographic watermarking allows the document to embed invisible codes that can identify the source of unauthorized copies or prints, ensuring that sensitive information remains traceable. Encrypted data transmission ensures that the document's content is protected during access, even in environments with limited security.

The new paradigm of smart documents also opens up possibilities for tiered access and usage differentiation. For example, a smart document can provide different levels of access based on the user's role or subscription tier. A basic user might only be able to view the document, while a premium user could have the ability to edit or input the document into an AI system for analysis. This level of control not only enhances user experience but also enables new business models, such as price differentiation based on usage.

By breaking free from the Gutenberg paradigm, smart documents redefine what it means to manage and interact with information in the digital age. They transform documents from static, passive objects into dynamic, intelligent entities capable of governing their own interactions. This shift not only addresses the limitations of legacy electronic documents but also unlocks new possibilities in access control, security, and document management. As organizations continue to navigate the complexities of the digital era, the adoption of smart documents represents a forward-thinking strategy that aligns with evolving technological and security demands, paving the way for a more secure, efficient, and innovative future.

As noted above, traditional document management systems often fall short in providing comprehensive control, leading to potential security risks and unauthorized dissemination. This is especially problematic for organizations handling sensitive information, as they must rely on the goodwill of recipients and legal frameworks to ensure compliance with confidentiality agreements and data protection policies.

The present disclosure addresses these challenges by introducing methods and systems for managing self-governing documents, which are capable of autonomously controlling access and interactions. In some aspects, a method involves maintaining records within the document itself to identify entities authorized to access specific portions of the document. Upon receiving a request from a remote interface, the self-governing document utilizes these records to determine whether the request is from an authorized entity. Depending on the outcome, the document either grants or denies access, thereby ensuring that control remains with the document owner even after distribution.

This approach can offer one or more of several advantages over traditional systems. It enables granular control over document access, providing for the identification of authorized entities and the specific portions of the document they can access. Additionally, it supports dynamic access management, including the ability to revoke access rights and manage temporary access permissions via the document itself. In some aspects, the disclosed approaches incorporate various security features, such as encrypted data transmission and cryptographic watermarking, to safeguard sensitive information and ensure compliance with organizational policies.

Furthermore, the systems and methods described herein can facilitate collaboration by enabling controlled sharing and printing of documents while maintaining a comprehensive audit trail of access requests and interactions. By embedding intelligence within the document, the systems and methods of this disclosure not only mitigate the risks associated with unauthorized dissemination but also enhance document management processes, providing a robust framework for secure and efficient information exchange in the digital age.

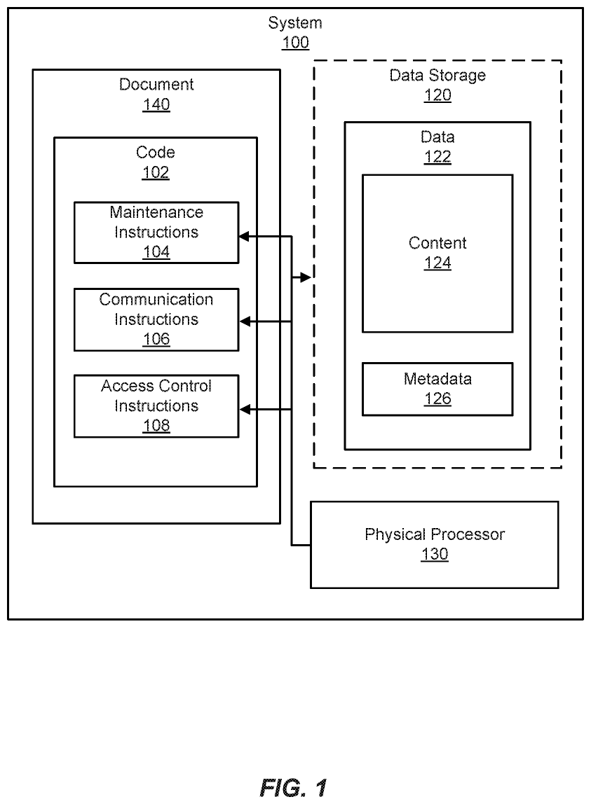

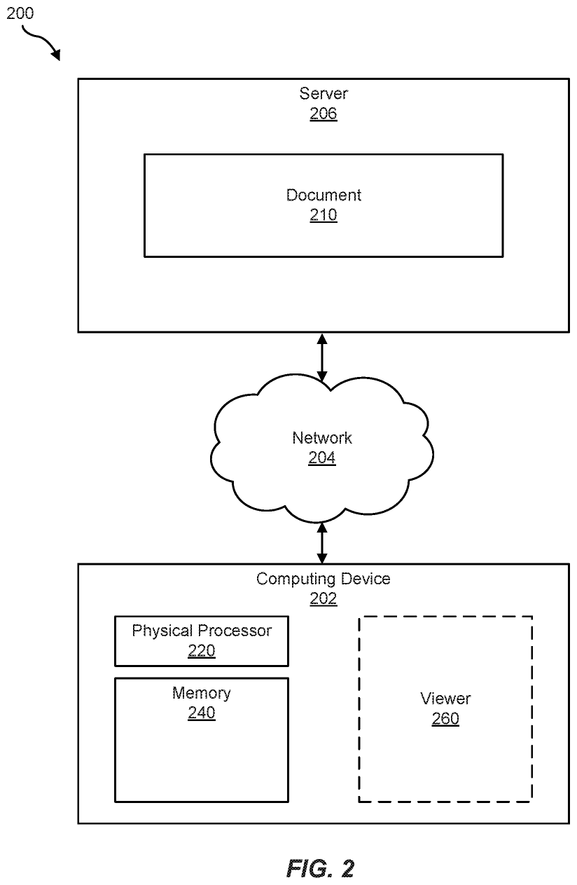

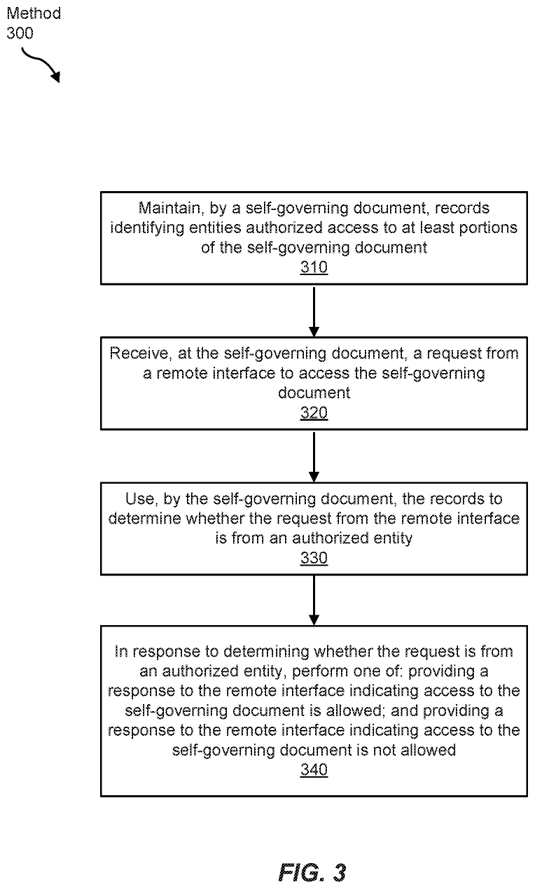

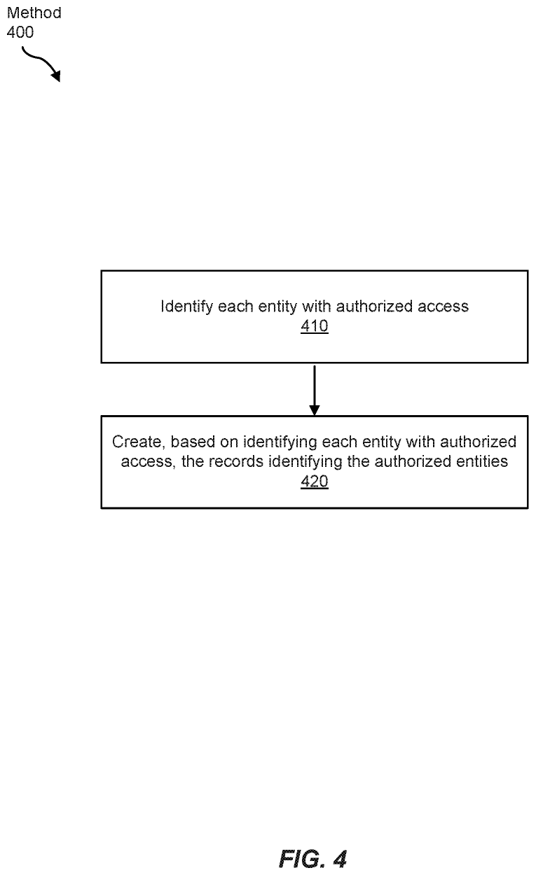

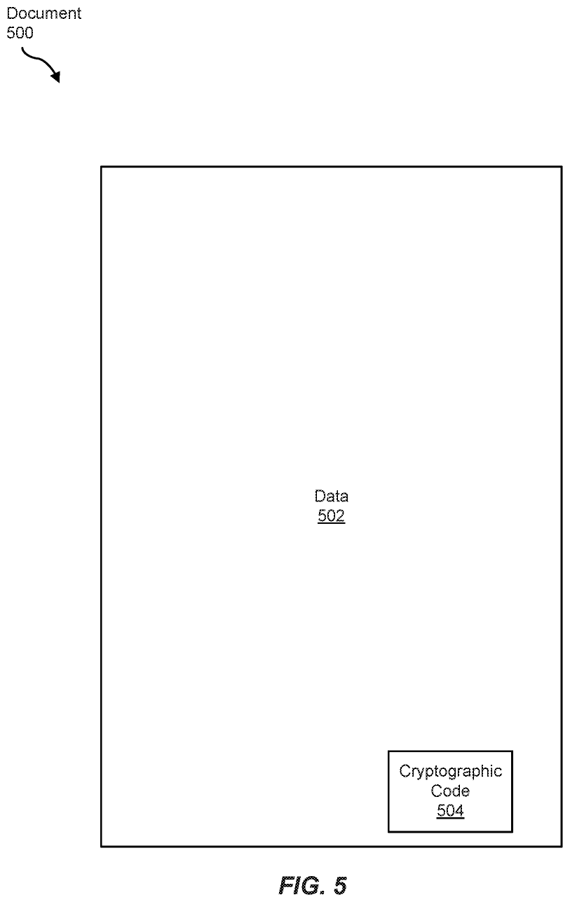

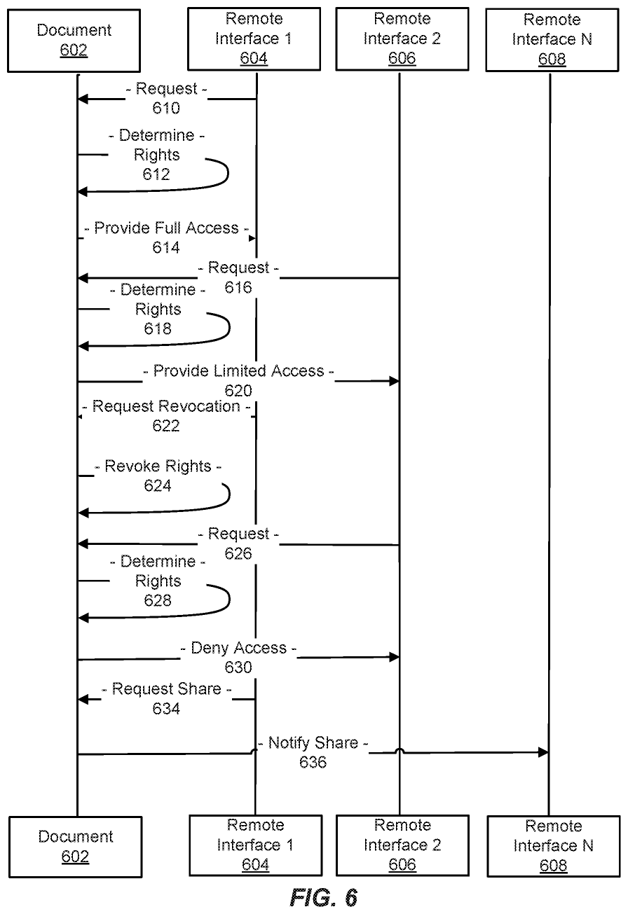

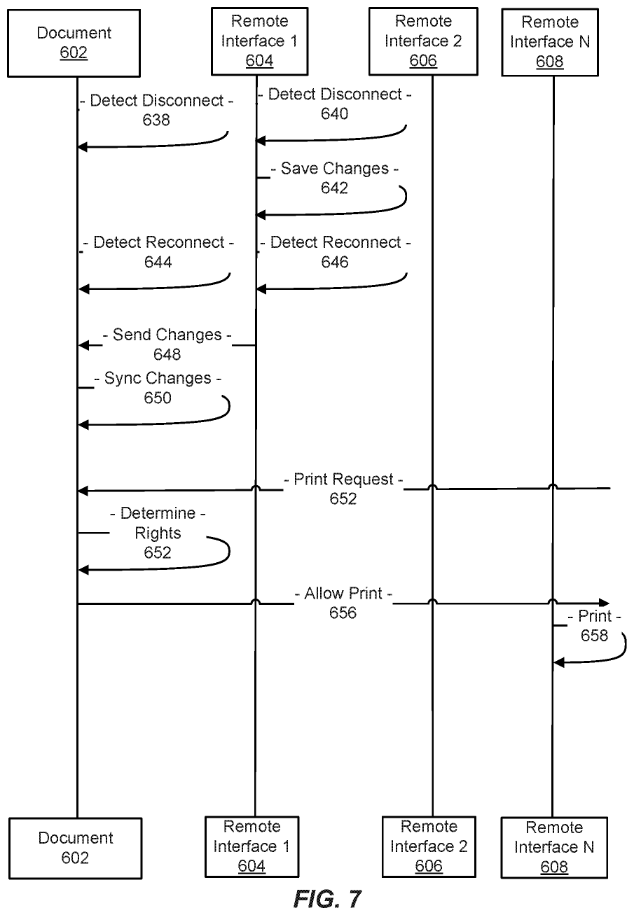

The accompanying figures provide a visual representation of the system architecture and processes of self-governing documents. FIG. 1 illustrates a system designed for creating self-governing documents, showcasing various interfaces and components that facilitate document creation, communication, and access control. This system also includes data storage and processing capabilities to support the execution of operations. FIG. 2 and the corresponding description present a networked document management system, highlighting the interaction between a computing device and a server through a network connection. This setup enables the hosting and display of documents, with the computing device equipped with processing and memory resources to manage document viewing. FIGS. 3-4 show flowcharts detailing methods of self-governing documents. These flowcharts outline steps such as maintaining records of authorized entities, receiving and responding to access requests, and identifying entities with authorized access. FIG. 5 illustrates the integration of security features within documents, such as cryptographic codes, to enhance protection and enable authentication. FIGS. 6 and 7 depict methods for managing access rights via a self-governing document, including determining rights, providing access, revoking rights, and handling share requests. The synchronization of changes across interfaces is also visualized, covering processes like detecting disconnections, saving changes, and synchronizing updates. Print requests and the determination of print rights are also addressed as part of the document management process, along with various other features.

FIG. 1 illustrates a System 100 designed for creating documents that can independently manage their own processes. The System 100 includes a Document 140 that has Document Governance Code 102. This Code 102 includes Maintenance Instructions 104, Communication Instructions 106, and Access Control Instructions 108. The System 100 also includes Data Storage 120, Data 122, and a Physical Processor 130. The Document 140 uses various interfaces and components to support document creation, communication, and access control.

The Document Governance Code 102 provides a set of instructions and protocols that enable the Document 140 to manage its own lifecycle and interactions independently. For example, the Maintenance Instructions 104 are responsible for maintenance of information, such as access rights, associated with the document. The Communication Instructions 106 enable interactions between remote interfaces and document 140. This interface allows the document to send and receive information, facilitating interactions with other systems and users. The Access Control Instructions 108 determine which entities are authorized to interact with the document, enforcing security protocols to prevent unauthorized access as discussed in greater detail herein.

Data Storage 120 provides the infrastructure for storing Data 122 associated with the Document 140. The System 100 ensures that all information related to the Document 140 is securely maintained and accessible only to authorized entities. Data Storage 120 interacts with the Physical Processor 130 to execute Document Governance Code 102.

The Physical Processor 130 in the context of FIG. 1 refers to the hardware component responsible for executing instructions and processing data related to the Document 140. It serves as the computational engine of the System 100, enabling the document to perform various operations autonomously. The Physical Processor 130 can be a single processor or a combination of multiple processors working together.

The Physical Processor 130 can be a Central Processing Unit (CPU) capable of handling general-purpose computing tasks. Alternatively, the Physical Processor 130 can be a specialized processor, such as Graphics Processing Units (GPUs), Field-Programmable Gate Array (FPGAs), or an Application Specific Integrated Circuit (ASIC). In distributed computing environments, the term “physical processor” can also refer to a network of interconnected processors working collaboratively. This setup can be used in cloud computing platforms, where processing tasks are distributed across multiple servers to optimize resource utilization and ensure scalability.

Data 122 represents the content and metadata of Document 140, encompassing all the information the document is intended to convey. The data is stored within Data Storage 120 and managed by Physical Processor 130 to ensure data integrity and accessibility.

In some examples, the data of a self-governing document can include two distinct components: content 124 and metadata 126, each serving a unique purpose in the document's functionality and lifecycle. Content 124 refers to the core information of the document, such as text, images, tables, or other embedded elements that constitute the primary substance of the document. This content is immutable, meaning it cannot be altered once the document has been finalized or authenticated. The immutability of content 124 ensures the integrity and trustworthiness of the document, making it suitable for applications where the original state of the document must be preserved, such as legal agreements, financial reports, or medical records.

On the other hand, metadata 126 represents supplementary information about the document, such as timestamps, user interactions, access logs, version history, or contextual details. Unlike the immutable content, metadata 126 is mutable and can be updated or modified as the document evolves. For example, metadata can record the identity of users who accessed the document, the time and date of interactions, or the addition of comments or annotations. This mutability allows the document to dynamically track its lifecycle and provide real-time insights into its usage and provenance. By separating immutable content from mutable metadata, the document achieves a balance between preserving its core integrity and enabling flexibility for operational and contextual updates. This dual structure ensures that the document remains both reliable and adaptable, meeting the needs of secure and dynamic digital environments.

Metadata plays a central role in the functionality and transformative potential of smart documents (i.e., documents that are digital infrastructure). It provides a structured, machine-readable layer of information that goes beyond the visual representation of a document, enabling advanced computational interactions, dynamic workflows, and granular access control. Metadata can be categorized into several distinct types, each serving a unique purpose in enhancing the utility and intelligence of a document. These categories include process metadata, semantic metadata, and content-related metadata, among others. Below is a detailed explanation of these metadata types, with examples drawn from the discussion.

Process metadata captures the history and lifecycle of a document, recording every action, interaction, and workflow the document has undergone. This type of metadata serves as an audit trail, providing a comprehensive record of the document's journey and the processes it has been part of. For example, process metadata might include timestamps for when the document was created, edited, shared, or signed. It could also log the identities of users who accessed the document, the nature of their interactions (e.g., viewing, commenting, or editing), and any changes made to the document's content or metadata.

Semantic metadata describes the intrinsic characteristics of a document, answering the question of “what the document is” rather than “what the document contains.” This type of metadata includes information about the document's type, ownership, and categorical classification. For example, semantic metadata might indicate that a document is an NDA (Non-Disclosure Agreement), a marketing presentation, or a financial report. It might also specify the document's owner, such as the individual or organization responsible for its creation and management.

Semantic metadata is particularly useful for organizing and categorizing documents within a system. For instance, in an enterprise setting, semantic metadata can be used to group all contracts under a “Legal Documents” category, all invoices under a “Finance Documents” category, and all marketing materials under a “Marketing Documents” category. This categorization enables efficient search and retrieval, as users can query the system to find all documents of a specific type or category.

Content-related metadata provides a structured representation of the document's content, breaking it down into machine-readable elements such as paragraphs, headings, tables, and images. This type of metadata enables advanced computational interactions with the document, such as semantic analysis, automated workflows, and dynamic rendering.

FIG. 2 shows a system 200 for managing electronic documents as smart digital objects. The System 200 includes a Computing Device 202, a Network 204, a Server 206, a Document 210, a Physical Processor 220, a Memory 240, and a Viewer 260. The Computing Device 202 communicates with the Server 206 through the Network 204 to facilitate the hosting and display of the Document 210.

The Computing Device 202 serves as the primary interface for users to interact with the System 200. The Computing Device 202 is equipped with a Physical Processor 220 and a Memory 240, which together enable the execution of operations related to document management. The Physical Processor 220 is responsible for processing instructions and data. The Memory 240 stores data and instructions necessary for the operation of the Computing Device 202, including information related to the Document 210.

The Network 204 provides the communication pathway between the Computing Device 202 and the Server 206. The Network 204 enables the transfer of data and instructions, allowing the Computing Device 202 to access and interact with the Document 210 hosted on the Server 206. The Network 204 can be implemented using various technologies, such as wired or wireless connections, to facilitate seamless communication.

The Server 206 hosts the Document 210, which is a self-governing digital object capable of managing access and interactions independently. The Server 206 provides the required infrastructure to store and process the Document 210, ensuring availability to authorized entities via the Network 204. The Document 210 incorporates intelligence to autonomously control access permissions and interactions, enabling security and management capabilities.

The Viewer 260 is a component of the Computing Device 202 that allows users to view and interact with the Document 210. The Viewer 260 provides a user interface for displaying the content of the Document 210, enabling users to access and manipulate the Document 210 as permitted by the embedded access controls. The Viewer 260 ensures that the Document 210 is presented in a user-friendly manner, facilitating efficient document management and collaboration.

Turning to FIG. 3, the method 300 is a process for a self-governing document to ensure secure access and control over its distribution and interaction. At step 310, a self-governing document maintains records identifying entities authorized to access at least a portion of a self-governing document. This step involves the self-governing document keeping records that identify entities authorized to access specific portions of the document and is part of creating a secure framework where access rights are clearly defined and stored within the document itself. The records serve as a reference point for the document to verify the legitimacy of access requests. This step can be performed in any suitable manner, including the use of encrypted databases or embedded metadata within the document, ensuring that the records are tamper-proof and accessible only to the document's internal processes. The records may include information such as entity identification, access levels, and other information.

In general, a self-governing document is an electronic document that possesses the capability to autonomously manage its own lifecycle, access permissions, and interactions with users and systems. Unlike traditional documents, which rely on external systems and manual processes for control and security, self-governing documents are embedded with intelligence that allows them to operate independently within a digital ecosystem.

A “self-governing document” generally refers to a type of electronic document equipped with embedded intelligence that enables it to autonomously monitor, record, and manage events associated with its lifecycle, access, and interactions. Unlike traditional documents, which require external systems or manual input to track changes and interactions, self-governing documents are designed to independently identify and log activities such as access attempts, modifications, and interactions with other documents or systems.

The embedded intelligence within a self-governing document allows it to maintain an audit trail, providing detailed insights into who accessed the document, when it was accessed, and what actions were taken. This capability is particularly valuable for ensuring compliance with regulatory requirements and organizational policies, as it offers a reliable record of all document-related activities.

Self-governing documents can also enhance security by dynamically managing access permissions, employing role-based access control, encryption, and multi-factor authentication to ensure that only authorized users can view or modify the document. By transforming documents into active entities capable of self-monitoring and self-regulation, organizations can significantly reduce the risk of unauthorized access and data breaches, while streamlining document management processes and maintaining data integrity. In general, the term self-governing document refers to code (i.e., intelligence), content, and metadata that form the self-governing document.

In some examples, a self-governing document is paradigm shift in the realm of digital information management, designed to autonomously monitor, record, and manage its own lifecycle, interactions, and provenance. Unlike traditional documents, which rely on external systems for tracking changes and interactions, a self-governing document embeds intelligence directly within itself, enabling it to function as an active entity. This embedded intelligence allows the document to independently identify events, such as access attempts, modifications, or interactions with other systems, and record these events as part of its metadata. By doing so, the document creates a comprehensive audit trail that remains inseparable from the document itself, ensuring transparency, accountability, and security throughout its lifecycle.

The attributes of a self-governing document are multifaceted and designed to address the limitations of traditional document management systems. First and foremost, a self-governing document is uniquely addressable, meaning it has a permanent and immutable identifier that distinguishes it from all other documents. This identifier ensures that the document can be reliably accessed and referenced, regardless of its location or the number of copies in existence. Additionally, the document is equipped with machine-readable metadata that captures detailed information about its interactions, such as timestamps, user credentials, geolocation data, and the nature of the interaction. This metadata is not only comprehensive but also structured in a way that supports automated processing and analysis, enabling advanced functionalities such as real-time auditing and compliance verification.

Another key attribute of a self-governing document is its ability to maintain version control. When changes need to be made to the document, a new uniquely addressable version is created, rather than altering the original document. This approach preserves the integrity of the original document while providing a clear record of its evolution. Each version is assigned its own unique identifier, ensuring that it can be independently accessed and verified. The relationship between versions is also recorded, creating a hierarchical structure that allows users to trace the document's history and understand the context of each modification. For example, if a contract is updated to include new terms, the updated version will reference the original version, enabling auditors to compare the two and verify the changes. The creation of new versions is governed by strict rules and cryptographic mechanisms to ensure authenticity and prevent unauthorized modifications. When a user or system initiates a change, the self-governing document generates a cryptographic signature that validates the modification and ties it to the new version. This signature is stored as part of the document's metadata, providing a tamper-proof record of the change. Additionally, the document's embedded intelligence ensures that all changes are logged in its audit trail, capturing details such as who made the change, when it was made, and why it was made. This level of detail not only supports transparency but also enhances security by making it virtually impossible to alter the document without leaving a trace.

In some examples, the immutability of the content in a self-governing document is a foundational characteristic that ensures the integrity, reliability, and trustworthiness of the document throughout its lifecycle. This immutability is achieved through a combination of technical mechanisms and design principles, which are explained below.

The “content” of a self-governing document refers to the core information that constitutes the document, such as text, images, tables, or other embedded elements. This content is distinct from metadata (which provides supplementary information about the document, such as timestamps, user interactions, and version history) and executable code (which enables the document's intelligent functionalities). The immutability applies specifically to the content, ensuring that it remains unchanged once the document is finalized or authenticated.

To ensure immutability, the content of a self-governing document can be cryptographically hashed at the time of its creation or finalization. A cryptographic hash is a unique, fixed-length string generated from the content using a hashing algorithm (e.g., SHA-256). This hash acts as a digital fingerprint of the content. If even a single character or pixel in the content is altered, the hash will change, making it immediately evident that the content has been tampered with.

Any system or user accessing the document can verify its integrity by recalculating the hash and comparing it to the original hash stored in the document's metadata. If the hashes match, the content is confirmed to be unchanged.

In cases where changes to the document are necessary (e.g., updates or amendments), the self-governing document does not alter the original content. Instead, it creates a new version of the document with its own unique identifier and cryptographic hash. The original version remains intact and accessible, ensuring that the history of the document is preserved.

Each version of the document is uniquely addressable and linked to the previous versions, creating a hierarchical structure that allows users to trace the evolution of the document. This approach ensures that the original content is never overwritten or lost.

In some embodiments, the self-governing document may leverage distributed ledger technology to ensure immutability. The content and its associated hash can be recorded on a distributed ledger, where each entry is cryptographically secured and immutable. This approach provides an additional layer of protection, as the blockchain ensures that the content cannot be altered without consensus from the network.

The self-governing document separates its content from other mutable elements, such as metadata and executable code. While metadata and code can be updated to reflect new interactions or functionalities, the content layer remains fixed and unchangeable. This separation ensures that the core information of the document is preserved, even as the document evolves in other ways.

The self-governing document provides transparency to users by enabling them to verify the authenticity and integrity of the content at any time. This transparency is achieved through audit trails and visual indicators.

Features of a self-governing document include one or more of autonomous access control, lifecycle management, security features, and dynamic interaction. Autonomous access control allows the document to independently determine who is authorized to access its content, based on predefined rules and records stored within, or otherwise accessible to, the document itself. This includes granting, revoking, or temporarily allowing access without requiring intervention from the document owner. Lifecycle management enables self-governing documents to manage their own lifecycle, including creation, modification, distribution, and deletion. They can track changes, maintain version control, and ensure data integrity throughout their existence. Security features can be incorporated into these documents, such as encryption, cryptographic watermarking, and authentication protocols, to protect sensitive information and prevent unauthorized access or modification.

Dynamic interaction enables self-governing documents to interact with external systems and users in real-time, responding to access requests, synchronizing changes, and facilitating collaboration while maintaining control over their content. Embedded intelligence within the document enables it to make decisions based on its internal records and algorithms, allowing for efficient and secure management of its interactions and data. Examples of self-governing documents include legal contracts that automatically enforce compliance with terms, confidential reports that restrict access based on user credentials, and collaborative documents that synchronize changes across multiple users and devices. By transforming traditional documents into intelligent entities, self-governing documents offer enhanced security, control, and efficiency in managing digital information.

In general, the term “entity” refers to any identifiable individual, group, organization, or system that interacts with or accesses a self-governing document. Entities are recognized based on specific attributes or credentials, which are used to determine their access rights and permissions concerning the document. Examples of entities include individual users, such as employees within a company, consultants, or external partners, who access the document with access rights determined by their role and credentials. Entities can also be defined as groups, such as a project team or department within an organization, where, for example, a marketing team might be granted access to specific promotional materials, while the finance department has access to budget reports. An entire organization can be considered an entity, especially when documents are shared between companies, such as a partner company accessing shared project documents under a non-disclosure agreement.

Automated systems or software applications that interact with the document, like a document management system that processes and archives documents, are additional examples of entities with specific access permissions. In some cases, entities can be devices used to access a document, such as computers, tablets, or smartphones, with access rights configured based on the device's security features or location. An entity can also be the software used to access a document, such as a remote viewer or interface.

Returning to FIG. 3, at step 320, the systems and methods described herein receive, at the self-governing document, a request from a remote interface to access the self-governing document. Step 320 can be performed in any suitable manner, and receiving requests generally involves the self-governing document receiving a request from a remote interface to access the document. This step involves the document's ability to interact with external entities while maintaining control over its content. The remote interface is any interface used by an entity to interact with the document. Upon receiving a request, the document initiates a verification process to ensure that the request originates from an authorized entity.

The term “remote interface” generally refers to any system, application, or platform that facilitates interaction with a self-governing document from a location that is not directly connected to the document's primary storage or processing environment. A remote interface serves as a bridge between the user or system and the document, enabling access, communication, and control over the document's content and features via the document's own application programming interface or interfaces. A remote interface may be designed to ensure secure and efficient interaction with the document, regardless of the user's physical location.

Examples of remote interfaces include graphical user interfaces (GUIs), which enable users to interact with the document through graphical elements such as buttons, icons, and menus. For instance, a web-based application with a GUI can enable users to view, edit, and manage a self-governing document from their browser, providing a user-friendly experience with intuitive navigation and controls. Such an application can also be referred to as a viewer. Mobile applications can also serve as remote interfaces, allowing users to access and interact with the document from their smartphones or tablets, providing flexibility and convenience for users on the go. Additionally, command-line interfaces can allow entities to interact with the document through text-based commands. By utilizing remote interfaces, self-governing documents can be accessed and managed securely from various locations and devices, ensuring that entities have the flexibility to interact with the document in a manner that suits their needs and preferences.

At step 330, the method 300 involves the self-governing document using the records it keeps to determine whether the request from the remote interface is from an authorized entity. Step 330 may be performed in any suitable manner and enables a document's autonomous control capabilities, allowing the document to independently verify access rights without external intervention. In some examples, the document cross-references the incoming request with stored records, checking for matching credentials or identifiers that confirm the requester's authorization. Additionally or alternatively, this step can involve advanced algorithms or machine learning techniques to enhance the accuracy and efficiency of the verification process, ensuring that only legitimate requests are granted access. Various examples of requests are described in more detail below in connection with FIGS. 6 and 7.

The term “authorized entity” generally refers to any individual, group, organization, or system that has been granted permission to access or interact with all or a portion of a self-governing document. Authorization is typically based on predefined criteria, such as credentials, roles, or attributes, which are used to determine the level of access and permissions an entity has concerning the document. The concept of an authorized entity enables maintaining security and control over document interactions, ensuring that only those with legitimate rights can access sensitive information. Examples of authorized entities include employees within a company who may be authorized to access specific documents based on their job roles or responsibilities, such as a financial analyst having access to budget reports or a marketing manager viewing promotional materials.

As another example, project teams working on specific initiatives may be granted access to documents related to their projects, like a team developing a new product accessing design documents, research data, and project plans. Departments within an organization, such as HR or legal, may have access to documents relevant to their functions, like employee records or contracts. External partners or consultants may be granted temporary access to documents necessary for collaboration, such as a consulting firm accessing reports and data for a strategic initiative. Automated systems, like document management systems, may be authorized to retrieve and update document data as part of their operations. In some cases, specific devices may be authorized to access documents based on security configurations or location, such as devices within a company's secure network. By defining authorized entities in this manner, self-governing documents can effectively manage access control, ensuring that interactions are secure and compliant with organizational policies, thereby protecting sensitive information and maintaining the integrity of document management processes.

At step 340, in response to determining whether the request is from an authorized entity, the self-governing document may either provide a response to a remote interface providing access or denying access to the self-governing document. In other words, step 340 involves the self-governing document responding to the access request based on the authorization determination. In response to determining whether the request is from an authorized entity, the document performs one of two actions: providing a response to the remote interface indicating access to the self-governing document is allowed, or providing a response to the remote interface indicating access to the self-governing document is not allowed. If access is allowed, the document may provide encrypted data to the remote interface, ensuring secure transmission and preventing unauthorized viewing. Conversely, if access is denied, the document sends a notification to the remote interface, indicating the lack of authorization and, in some examples, providing instructions for obtaining access rights.

Turning to FIG. 4, the method 400 is a structured approach for managing access to self-governing documents, ensuring that only authorized entities can interact with specific portions of the document or all of the document. At step 410, a self-governing document identifies each entity with authorized access, serves as the initial step in establishing a secure framework for document access control. This component involves the self-governing document systematically identifying entities that are permitted to access specific portions of the document.

At step 420, the self-governing document creates records identifying the authorized entities. These records serve as a reference point for the self-governing document to verify the legitimacy of access requests. The creation of records can be implemented using secure data storage solutions, such as encrypted databases or embedded metadata within the document. These records are designed to be tamper-proof and accessible only to the document's internal processes, ensuring that they cannot be altered or accessed by unauthorized entities.

As an example of the process depicted in FIG. 4, a company can utilize document control provided by self-governing documents to manage access to documents by identifying authorized entities and creating records based on this identification. For instance, the company can determine which individuals within the organization are permitted to access specific documents, whether on a department level, position level, deal level, or through any other ad hoc approach. At a high level, an administrator can view the organizational structure and decide which departments or individuals should have access to particular documents. For example, the administrator might decide that certain documents should only be accessible to the CEO and the Board of Directors, while others, like the employee handbook or company policies, should be available to all employees.

Additionally, documents specific to one division, such as the classic division, might be restricted from other divisions due to the lack of relevance to their business operations. This compartmentalization of document access is achievable because the documents have been converted into self-governing documents, a level of control not possible in traditional ecosystems. Beyond using the organizational structure to guide access privileges, the administrator can also establish ad hoc groups for document access. For example, groups such as Independent Directors and Officers or Attorneys, Managers, and Investor Relations can be created. The controller can then grant or revoke access to these groups collectively. Over time, the administrator can develop a comprehensive list of ad hoc groups to efficiently manage access to specific documents.

FIG. 5 shows a Document 500 designed to manage access and interactions autonomously. The Document 500 comprises Data 502 and a Cryptographic Code 504. This configuration allows the Document 500 to securely store and manage information while ensuring that access is controlled and tracked through embedded security features.

The Data 502 represents the content associated with the Document 500. This data encompasses all the information that the document is intended to convey, which can range from text and images to complex data structures. The Cryptographic Code 504 is a security feature embedded within the Document 500.

In the example shown in FIG. 5, Cryptographic Code 504 can be exemplified by cryptographic digital watermarking integrated into printed versions of the document. This process can involve embedding an invisible (e.g., invisible or indecipherable to human readers) code within the printed document, which is not readily apparent to a person who prints and reads the document but is legible to a machine programmed to recognize and interpret it. For instance, select pixels within the document may be printed in specific locations or colors, or slightly varied shades of the color associated with the field in which they exist. These microscopic printed pixels are not noticeable to the user but are legible to the system, enabling it to identify the source of a printed version after the fact. The encoding of which pixels to print can be unique for each user, similar to a QR code. In one example, a QR code can be associated with the user and/or the document, and simultaneously, an invisible encoded version of the QR code can be integrated into the document through cryptographic digital watermarking. Thus, while the user is aware that the document is not supposed to be copied and that the visible QR code is present to track the source if improper copies are made, they may be unaware of the cryptographic digital watermarking that can also track the source if the visible QR code is circumvented.

Other techniques can be employed alongside or instead of the pixel-based approach. For example, encoding can be rendered by slightly modifying the font of particular characters in a way that is not noticeable to the user who prints, reads, and copies the document, but is readily decipherable by a computer programmed to decode the altered fonts and identify the source of unauthorized printing. Additional subtle methods of rendering this coding process include slightly varying the spacing between characters, words, or lines, slightly varying the indentation of lines, slightly varying the angle of particular characters, words, or lines, or slightly varying the background color associated with particular characters or portions thereof.

In a related embodiment, the cryptographic digital watermarking approach can also be applied to screen displays of the document, employing the same techniques in cases where the user improperly takes screenshots or photos of the displayed document. The encoding of the display can change each time the user opens the document, allowing the system to determine not only which user is the source of an unauthorized screenshot or photo but also pinpoint the time and place where it was taken. This dynamic approach can also be applied to the print scenario, where each time the user prints the document, the encoding varies slightly. Thus, the controller will be aware that the user printed the document—since the system first confirms authorization and subsequently enables printing and tracks the event—but the system will also maintain the coding information so that if the authorized printer makes unauthorized copies of the printed document, this can be discovered and remedied appropriately.

FIG. 6 illustrates a comprehensive system for managing access and interactions with self-governing documents through multiple interfaces. This figure highlights the dynamic and autonomous capabilities of the document, which is embedded with intelligence to control access permissions and respond to various requests. The system is designed to ensure that only authorized entities can access specific portions of the document, thereby maintaining security and integrity. By integrating multiple interfaces, the system facilitates seamless communication and interaction between the document and external entities, allowing for granular control over document access. The figure demonstrates the process of determining access rights, providing full or limited access, revoking rights, and handling share requests, showcasing the robust framework for secure and efficient information exchange.

FIG. 6 exemplifies competitive interactions by illustrating how multiple parties can simultaneously access and interact with a self-governing document, such as in auction scenarios. Each remote interface—Interface 1 (604), Interface 2 (606), and Interface N (608)—is utilized by different entities to access the Document 602, enabling concurrent interactions with the document.

For example, in an auction setting, various participants may need to access the same document to review bidding information, submit offers, or track auction progress. FIG. 6 demonstrates how the system accommodates these simultaneous interactions by providing distinct interfaces for each entity. Interface 1 (604) might be used by one bidder to access the document and submit a bid, while Interface 2 (606) could be employed by another bidder to review the current highest bid and adjust their offer accordingly. Interface N (608) represents how N additional participants can engage with the document, ensuring that all parties have the opportunity to interact with the document in real-time.

The system's ability to manage multiple access requests concurrently is crucial in competitive environments like auctions, where timing and responsiveness are key. Each interface processes requests independently, determining access rights and providing the necessary level of access—whether full or limited—based on the entity's credentials. This setup ensures that all participants can engage with the document without interference, maintaining the integrity and fairness of the auction process.

In addition to auctions, there are various other scenarios where multiple entities may need to access a document simultaneously, leveraging the system's ability to manage concurrent interactions. For example, in collaborative editing environments, team members may need to access and edit a shared document at the same time, such as during a project meeting where multiple participants update a project plan or contribute to a report in real-time, ensuring synchronized changes visible to all involved. Contract negotiations often require representatives from different organizations to access the same document to review terms, propose amendments, and finalize agreements, with each party using a separate interface to interact with the document collaboratively.

In corporate settings, board members may access the same set of documents during meetings to review financial reports, strategic plans, or other critical information, allowing for informed discussions and decision-making. Regulatory compliance reviews in industries subject to oversight may involve multiple auditors or compliance officers accessing the same document to verify adherence to legal and regulatory requirements, facilitating efficient review processes. In educational contexts, students and instructors may access the same document for collaborative learning activities, such as group projects or peer reviews, promoting dynamic and interactive learning experiences. Customer support scenarios may require multiple support artificial intelligence agents to access the same document to resolve complex issues or provide consistent information to customers, ensuring that all artificial intelligence agents have the latest information and can collaborate effectively to address customer needs. These examples demonstrate the versatility of the system in accommodating multiple entities accessing a document simultaneously, supporting a wide range of collaborative and competitive interactions across various industries and contexts.

The process flow between Document 602 and Remote Interfaces 604, 606, and 608, as illustrated in FIG. 6, demonstrates the dynamic interaction and access management capabilities of the system. This example involves Remote Interface 1 604 sending a request to Document 602 (step 610), initiating the access evaluation process where the document assesses the credentials and permissions associated with the entity using Remote Interface 1 604. Upon receiving this request, Document 602 evaluates the access rights of the entity using Remote Interface 1 604 (step 612), checking stored records to verify whether the entity is authorized to access the document and to what extent. If the evaluation confirms full access rights, Document 602 grants full access to Remote Interface 1 (step 616), allowing comprehensive interaction with the document.

Remote Interface 2 606 may also send a request (step 616), prompting an evaluation of access rights (step 618). In response to this assessment, the Document 602 provides limited access to Remote Interface 2 606 (step 620), allowing interaction with specific portions of the document to protect restricted information in other parts of the document. Remote Interface 1 can also initiate a request to revoke access rights for Remote Interface 2 606 (step 622), prompting Document 602 to determine that Remote Interface 1 604 has this right and, in response to this determination, update its records and restrict access accordingly by revoking rights from Remote Interface 2 606 (step 624). When Remote Interface 2 606 sends another request to the Document 602 (step 626), the Document 602 reevaluates the access rights for the entity using Remote Interface 2, verifying credentials and determining the appropriate level of access (step 628). When the evaluation concludes that the entity lacks necessary permissions, Document 602 denies access (step 630), preventing unauthorized interaction and safeguarding sensitive information.

Remote Interface 1 604 can initiate a request to share the document with an entity using Remote Interface N 608 (step 634), prompting Document 602 to evaluate sharing permissions. Document 602 processes the share request and notifies Remote Interface N 608 of the sharing action (step 636), facilitating controlled document distribution and ensuring compliance with organizational policies and security measures. This process flow illustrates the system's ability to manage multiple access requests from different entities and interfaces, providing a robust framework for secure and efficient document management.

FIG. 7 illustrates additional steps involved in managing access and interactions with a self-governing Document 602. The process begins with Document 602 monitoring the connection status with Remote Interface 1 604 and detecting a disconnect (step 638), which can be due to any loss of connectivity due to network issues or intentional disconnection by a user or other entity. Similarly, the Remote Interface 1 can detect the disconnect (step 640). During a disconnection, the Remote Interface 1 604 may save any changes made to the metadata of the Document 602 (step 642), providing for any modifications made to the Document 602 via Remote Interface 2 being stored locally and saving them for reconciliation once the connection is reestablished.

The Document 602 and the Remote Interface 1 604 may detect reconnection (steps 644 and 646, respectively), initiating processes to synchronize changes made during the disconnection and ensuring the document remains consistent across all interfaces. Once reconnection occurs, the Remote interface 604 sends changes made during disconnection to the Document 602 (step 648). The Document 602 may then synchronize the changes (step 650), reconciling modifications made during the disconnection, maintaining document consistency and addressing any discrepancies or conflicts.

In some examples, the process shown in steps 638-650 involves managing encrypted data of a self-governing document when the remote interface experiences periods of disconnection from a document. This process can ensure that the document remains secure and consistent across all interfaces, even when accessed offline.

In some examples, a self-governing document can enable the encrypted data to be decrypted and displayed via the remote interface, even when the interface does not have a network connection. This capability is particularly useful for users who need to access the document in environments where network connectivity is unreliable or unavailable, such as during travel or in remote locations. For example, a field researcher might need to access encrypted data while conducting studies in areas without internet access. The self-governing document enables the researcher to decrypt and view the data offline, ensuring continuity in their work.

During the period of disconnection, any changes made to the document via the remote interface are stored locally. This local storage ensures that modifications are not lost and can be reconciled once the network connection is restored. For instance, if a user edits a report while offline, those changes are saved locally on their device.

Once the connection to the remote interface is restored, the self-governing document can initiate a reconciliation process, as discussed above. This process can involve comparing the locally stored data with the data maintained by the self-governing document on its server. The objective can be to identify and reconcile any differences between the two versions, ensuring that the document remains consistent across all interfaces. For example, if a user added new comments to a document or otherwise interacted with the document while offline, the reconciliation process would update the document to include these changes.

The reconciliation process may employ various techniques to ensure data integrity and consistency. These techniques can include synchronization algorithms that merge changes from multiple sources, conflict resolution strategies to address discrepancies, and version control systems to track modifications.

Returning to FIG. 7, the Remote Interface N 608 may request printing all or a portion of the Document 602 (step 652), initiating the evaluation of printing permissions at the Document 602 (step 652). The Document 602 determines that the entity using Remote Interface N 608 has print rights and grants permission to Remote Interface 2 to print the document (step 656), ensuring controlled and monitored printing. Finally, Print involves Remote Interface 2 executing the print command (step 658), generating a physical copy of the document with any security features, such as watermarks or cryptographic codes, applied. These steps collectively illustrate the system's ability to manage access, interactions, and modifications across multiple interfaces, providing a robust framework for secure and efficient document management.

The process of managing access to self-governing documents can also involve any other suitable steps. In some examples, a document may enforce temporal control, a feature that is challenging to provide in traditional document ecosystems. Temporal control can enable precise management of document access over time.

Some examples involve using the records maintained by a self-governing document to determine whether a request from a remote interface is from an authorized entity. This determination includes assessing whether the entity has a temporary right to access the document. An administrator can specify the duration for which an individual or other entity is granted access to a document. This capability can be particularly useful for sensitive and confidential documents, where access might be restricted to a specific timeframe. The self-governing document cross-references any request with its records to verify if the entity's access rights are valid and temporary, ensuring that only authorized entities can interact with the document during the designated period.

Once the self-governing document confirms that the entity has a temporary right to access, it provides a response to the remote interface being used by the entity indicating that access is allowed for a predetermined period of time. This response can communicate the specific duration for which the entity can access the document. The administrator can set this period in various units, ranging from years to seconds, depending on the document's sensitivity and an organization's requirements. This flexibility allows for tailored access management, ensuring that documents are accessible only when necessary and reducing the risk of unauthorized dissemination.

If the request is made beyond the predetermined period of time, the self-governing document provides a response to the remote interface indicating that access is not allowed. This step can maintain the integrity and security of the document, as it prevents entities from accessing the document once their temporary rights have expired. By enforcing these temporal restrictions, the self-governing document ensures compliance with organizational policies and protects sensitive information from unauthorized access. The ability to control access duration so precisely also opens up new business opportunities, enabling organizations to manage document interactions dynamically and securely.

In addition to temporal limitations and other access restrictions, document content can be protected via encryption. The process of providing encrypted data of a self-governing document to a remote interface can involve several steps that ensure secure access and control over the document's content. This approach can protect sensitive information and maintain the integrity of the document when it is accessed remotely.

As an example, the self-governing document can encrypt its data before transmitting it to the remote interface. Encryption can transform the document's content into a format that can only be read by authorized entities possessing the correct decryption key. This can ensure that the document remains secure during transmission and prevents unauthorized access. For example, a company might encrypt a confidential report before sending it to a partner organization, ensuring that only individuals with the appropriate decryption key can access the report's content.

Once the encrypted data is provided to the remote interface, the self-governing document indicates the conditions under which the data can be decrypted and displayed. In one example, the encrypted data is allowed to be decrypted and displayed via the remote interface only while the remote interface maintains a network connection with the self-governing document. This approach ensures that the document owner retains control over the document's access, as the remote interface must remain connected to the document's server to view the content. For instance, a law firm might use this method to share sensitive case files with external consultants, ensuring that the files can only be accessed while the consultants are connected to the firm's secure network. If the network connection is lost, the document becomes inaccessible, preventing unauthorized offline access.

In some examples, the encrypted data can be allowed to be decrypted and displayed via the remote interface both while the remote interface maintains a network connection with the self-governing document and when the remote interface does not have a network connection as discussed with respect to FIG. 7 above. This scenario provides more flexibility, allowing users to access the document offline after initial decryption. For example, a research institution might share encrypted data with a collaborator who needs to work on the data during travel, where network access may be intermittent. The collaborator can decrypt and view the data offline, but the self-governing document ensures that any changes made offline are synchronized once the network connection is restored.

In both scenarios, the self-governing document can employ advanced security features, such as cryptographic watermarking, to track access and modifications. This ensures that any unauthorized attempts to copy or distribute the document can be traced back to the source. Additionally, the document may require periodic re-authentication to verify the user's credentials, further enhancing security.

In some examples, a self-governing document can implement a tiered access system. One example of such a system is an access system for distributing newsletters, allowing for differentiated levels of interaction based on customer profiles and needs. In this example, a self-governing document enables certain customers to merely read the newsletter, while others may have enhanced permissions, such as the ability to input the newsletter into their AI systems for further analysis. Such tiered access not only enhances user experience but also enables alignment with strategic business goals by tailoring access to the specific requirements of different customer segments.

As another example, a self-governing document can leverage tiered control to implement price differentiation strategies, ensuring that the value provided by the newsletter is appropriately compensated. For instance, the author of a stock-picking newsletter can set different price points for different users, rather than adopting a one-size-fits-all pricing model. An individual investor using the newsletter to guide personal investment decisions can be offered a lower price, with access restrictions that prevent forwarding the document to others. Conversely, a hedge-fund manager handling large investments for public pension funds can be charged a higher price, reflecting the greater value derived from the newsletter. This price can vary based on factors such as the duration of access, the number of times the document is accessed, and the number of colleagues with whom the document is shared.

This approach allows for two types of price differentiation: user differentiation, where pricing is based on the type of user, and usage differentiation, where pricing is based on how the document is used. Both strategies can be effectively managed and enforced because the newsletter is provided by a self-governing document. Self-government can ensure that an author retains control over the document, enabling them to monitor and regulate access, usage, and distribution in accordance with the established pricing and access policies. By employing these strategies, the author can maximize revenue potential while delivering tailored value to each customer segment.

Self-governing documents are designed to autonomously manage access permissions based on predefined conditions, ensuring that access is granted or revoked dynamically in response to specific criteria. Below are detailed examples illustrating scenarios where a self-governing document initially provides access but revokes it if certain conditions are not met.

In one example, an architectural firm shares a set of detailed building plans with a client through a self-governing document. Upon sharing, the document grants the client access to view and download the plans, enabling them to review the designs and provide feedback. However, the document is programmed to monitor payment conditions. If the client fails to make the agreed payment within 30 days, the document automatically revokes access. The revocation process involves the document updating its internal records to mark the client as unauthorized, and any subsequent attempts to access the document result in a denial message. Additionally, the document may notify the client of the revoked access and provide instructions for reinstating access, such as completing the overdue payment.

As another example, a financial research firm distributes a self-governing document containing a proprietary market analysis report to subscribers. Upon receipt, the document grants access based on the subscriber's active subscription status. The document continuously monitors the subscription's validity by checking its expiration date against the firm's subscription database. If the subscription lapses without renewal, the document revokes access, preventing the subscriber from viewing or downloading the report. The document may also display a notification to the subscriber, informing them of the expired subscription and providing a link to renew it. This ensures that only active subscribers can access the firm's valuable research.

As another example, an online learning platform provides self-governing documents containing course materials to students. Upon enrollment, the document grants access to the materials, allowing students to study and complete assignments. However, the document is programmed to revoke access if the student fails to complete a required exam within the course's timeline. For example, if the student does not take the exam within 60 days, the document revokes access to the course materials, ensuring that only students who actively participate in the course can continue accessing the content. The document may also notify the student of the revoked access and provide instructions for regaining access, such as scheduling and completing the exam.

As another example, an investment firm shares a self-governing document containing a detailed proposal with potential investors. The document initially grants access, allowing investors to review the proposal and provide feedback. However, the document is programmed to revoke access if the investors fail to submit feedback within a specified timeframe, such as 10 business days. If the deadline passes without feedback, the document updates its records to mark the investors as unauthorized and restricts further access. The document may also notify the investors of the revoked access and provide instructions for regaining access, such as submitting the required feedback or requesting an extension.

As another example, an event organizer sends a self-governing document containing an invitation to a private event. The document initially grants access, allowing recipients to view event details and RSVP. However, the document is programmed to revoke access if the recipient fails to RSVP by the specified deadline, such as 5 days before the event. If the deadline passes without an RSVP, the document restricts access and displays a notification informing the recipient that the invitation has expired. The document may also provide instructions for regaining access, such as contacting the organizer to request an exception.

These examples demonstrate the versatility of self-governing documents in managing access dynamically based on predefined conditions. By autonomously granting and revoking access, these documents ensure compliance, security, and accountability in various scenarios.

Self-governing documents can also incorporate embargo mechanisms to control the timing of access to sensitive information. An embargo use case might involve a press release scheduled for publication at a specific time. The document itself enforces the embargo by restricting access until the designated release time, ensuring that no unauthorized parties can view or disseminate the information prematurely. For example, a company preparing to announce quarterly earnings can distribute the press release to journalists in advance, but the document remains inaccessible until the embargo lifts. This capability is particularly valuable in industries such as media, finance, and government, where timing is critical to maintaining confidentiality and compliance.

Embargo mechanisms embedded within self-governing documents provide granular control over access, allowing document owners to specify not only the release time but also the conditions under which access is granted. For instance, the document can enforce additional restrictions, such as limiting access to specific geographic regions or requiring authentication before viewing. Once the embargo period ends, the document autonomously updates its access permissions, enabling authorized users to interact with the content. This dynamic approach to access control ensures that sensitive information is protected while still being accessible at the appropriate time.

By embedding embargo functionality directly within the document, self-governing documents eliminate the need for external systems to enforce timing restrictions. This reduces complexity and enhances security, as the document itself becomes the authoritative source for managing access. Embargo mechanisms also provide a comprehensive audit trail, recording all access attempts and interactions during the embargo period. This ensures accountability and transparency, making self-governing documents an ideal solution for managing time-sensitive information in a secure and efficient manner.

Action-based access control in self-governing documents allows permissions to be granted or revoked based on specific user actions. For example, a document might require a user to complete a training module before gaining access to sensitive content. Once the user successfully completes the required action, the document autonomously updates its access permissions, granting the user the ability to view or interact with the content. This approach ensures that access is contingent on predefined criteria, enhancing security and compliance.

Another example of action-based access involves collaborative editing. A document might allow users to suggest edits but restrict the ability to finalize changes until a designated reviewer approves them. In this scenario, the document tracks user actions, such as submitting edits or providing feedback, and dynamically adjusts access permissions based on the workflow. This ensures that only authorized users can perform critical actions, such as approving changes or publishing the final version.

Action-based access control is particularly useful in environments where user interactions must be carefully managed, such as legal, healthcare, and financial industries. By embedding these mechanisms directly within the document, self-governing documents provide a flexible and secure framework for managing access based on user actions. This not only enhances security but also streamlines workflows, as the document autonomously enforces access rules without requiring manual intervention.

Blacklisting in the context of access management involves explicitly denying access to certain users, devices, or systems based on predefined criteria. Self-governing documents can implement blacklisting to prevent unauthorized interactions, ensuring that sensitive information remains secure. For example, a document might blacklist a user who has violated confidentiality agreements, revoking their access to the document and any related content. Similarly, the document can blacklist devices or IP addresses associated with suspicious activity, preventing unauthorized access attempts.

Blacklisting can also be used to enforce geographic restrictions. For instance, a document containing sensitive trade secrets might blacklist access from specific countries or regions to comply with export control regulations. The document autonomously monitors access attempts and denies permissions to blacklisted entities, ensuring compliance with legal and organizational policies. This capability is particularly valuable in industries such as defense, technology, and pharmaceuticals, where geographic restrictions are critical to maintaining security.

By embedding blacklisting functionality directly within the document, self-governing documents provide a robust framework for managing access control. This eliminates the need for external systems to enforce restrictions, reducing complexity and enhancing security. Blacklisting also provides a comprehensive audit trail, recording all denied access attempts and interactions. This ensures accountability and transparency, making self-governing documents an effective solution for managing sensitive information in a secure and compliant manner.

Version-level access control in self-governing documents allows permissions to be managed independently for each version of a document. This ensures that users can only access the specific version they are authorized to view, enhancing security and compliance. For example, a legal contract might have multiple versions, with earlier drafts accessible to all collaborators but the final version restricted to senior management. The document autonomously enforces these access rules, ensuring that users can only interact with the versions they are permitted to access.

Version-level access is particularly useful in collaborative environments, where multiple stakeholders contribute to a document's development. For instance, a research paper might have different versions shared with co-authors, reviewers, and publishers, each with varying levels of access. The document tracks these interactions and dynamically adjusts permissions based on the user's role and the version they are accessing. This ensures that sensitive information remains protected while still enabling collaboration. By embedding version-level access control directly within the document, self-governing documents provide a flexible and secure framework for managing permissions. This eliminates the need for external systems to enforce version-specific restrictions, reducing complexity and enhancing security. Version-level access also provides a comprehensive audit trail, recording all interactions with each version of the document. This ensures accountability and transparency, making self-governing documents an ideal solution for managing version-specific access in collaborative and regulated environments.

Self-governing documents can extend access control mechanisms to attachments, ensuring that all associated content is managed securely. For example, a report might include an attachment containing raw data, with access to the attachment restricted to specific users. The document autonomously enforces these restrictions, ensuring that only authorized users can view or interact with the attachment. This capability is particularly valuable in industries such as finance, healthcare, and research, where attachments often contain sensitive information.

Access control for attachments can also be dynamic, adjusting permissions based on user actions or document lifecycle stages. For instance, a project proposal might include an attachment with budget details, accessible only to the finance team during the review phase. Once the proposal is approved, access to the attachment can be expanded to include project managers and stakeholders. The document tracks these interactions and updates permissions accordingly, ensuring that access remains aligned with organizational policies.

A smart document is designed to ensure the integrity, authenticity, and traceability of its content and associated audit trail through the use of immutability, a global marker, and embedded intelligence. This innovative structure addresses longstanding challenges in document management, auditing, and compliance.

### Immutable Content

The content of a smart document is immutable, meaning it cannot be altered once finalized. This immutability is achieved through cryptographic techniques, such as hashing and digital signatures. When the document is created, its content is hashed to produce a unique cryptographic fingerprint. This hash is stored alongside the document and serves as a reference for verifying the integrity of the content. Any attempt to modify the content would result in a mismatch between the original hash and the hash of the altered content, immediately signaling tampering. Additionally, the document may be digitally signed using the creator's private key, ensuring that the content is not only unchangeable but also verifiable as originating from the authorized source.

### Immutable Audit Trail

The audit trail of a smart document is equally immutable. The audit trail records every interaction with the document, including access, modifications, approvals, signatures, and other events. Each event in the audit trail is cryptographically secured and timestamped, ensuring that the sequence of events is preserved and cannot be altered retroactively. For example, when a user accesses the document, the system generates a cryptographic record of the access event, including the user's identity, the time of access, and the nature of the interaction. These records are stored in a manner that prevents deletion or modification, ensuring the audit trail remains a reliable source of truth. The audit trail is also linked to the document's content, creating a unified record of both the document and its history.

### Immutable Connection to a Permanent Global Marker

Both the immutable content and the immutable audit trail are connected to an immutable global marker, which serves as the unique and unchanging identifier for the document. The global marker can be implemented as a universally unique identifier (UUID) or a cryptographic address, such as a hash-based identifier. This marker is permanent and does not change throughout the lifecycle of the document, regardless of how or where the document is accessed. The global marker ensures that the document can always be referenced and retrieved in its original form, providing a single source of truth.

The connection between the content, audit trail, and global marker may be established through cryptographic linking. The global marker is embedded in the document's metadata, and the metadata itself is cryptographically secured to prevent tampering. The audit trail is also linked to the global marker, ensuring that every recorded event is associated with the correct document. This triad—immutable content, immutable audit trail, and an immutable association between the global marker and the content and audit trail—creates a robust framework that is changing document management and control.

The immutability of the content, the audit trail, the global marker and of the link between the marker and the data (i.e., the content, the audit trail, and any other metadata) and the global marker, can have one or more of a variety of characteristics:

Unchangeable: Immutable refers to something that cannot be altered, modified, or edited once it has been created or finalized.

Permanent: Immutable signifies a state of permanence, where the object or data remains fixed and consistent over time.

Irreversible: Immutable describes a condition where changes are impossible, and any attempt to alter the object or data is invalid or rejected.

Fixed: Immutable means that the structure, content, or state of an object is locked and cannot be adjusted or updated.

Tamper-Proof: Immutable implies that the object or data is resistant to tampering, ensuring its integrity and authenticity.

Finalized: Immutable refers to an object or data that has reached its final form and cannot be reverted or reshaped.

Unmodifiable: Immutable describes a characteristic where the object or data is impervious to modification, whether intentional or accidental.

Consistent: Immutable ensures that the object or data remains consistent and reliable, unaffected by external influences or changes.

Secure: Immutable denotes a state of security where the object or data is safeguarded against unauthorized alterations or corruption.

Indelible: Immutable refers to something that is permanent and cannot be erased, overwritten, or replaced.

### Benefits of the Immutable Structure

Integrity: The immutability of the content ensures that the document remains unchanged and trustworthy throughout its lifecycle.

Traceability: The immutable audit trail provides a complete and verifiable history of all interactions with the document.

Authenticity: The permanent global marker guarantees that the document can always be uniquely identified and retrieved, eliminating ambiguity.

Compliance: This structure simplifies regulatory compliance by providing a reliable and tamper-proof record of the document and its history.

Interoperability: The global marker enables seamless integration with external systems, ensuring that the document can be referenced and verified across different platforms.

In summary, a smart document achieves immutability of its content and audit trail while ensuring both are immutably connected to a permanent global marker. This design provides a solution for document management, offering unparalleled integrity, authenticity, and traceability.

While in some examples of smart documents the content, the audit trail, and the link to the global marker are all immutable, in other examples one of or two of these three items may be immutable. In some examples, the entirety of the content and the audit trail are immutable, and in others only a portion of the content and/or the audit trail are immutable. Furthermore, a smart document may have content and an audit trail that are immutable while having other metadata that is changeable (e.g., comments, access rights, etc.)

In addition to the foundational features of immutability, smart documents possess embedded intelligence that enables them to actively interact with their environment, respond to requests, and perform actions autonomously. This intelligence transforms the document from a static repository of information into a dynamic, interactive entity capable of understanding and adapting to its context. Embedded intelligence in smart documents is achieved through the integration of executable code, metadata, and machine-readable content, all of which work together to create a responsive and self-aware system.

### Features of Embedded Intelligence

Self-Determination and Responsiveness: Smart documents are equipped with the ability to process requests and respond dynamically. For example, when a user or system queries a document, the embedded intelligence allows the document to access its metadata, audit trail, and content to determine the appropriate response. This responsiveness is not limited to simple data retrieval; the document can also perform complex operations, such as verifying its authenticity, providing access logs, or extracting specific information from its content.

Contextual Awareness: Smart documents can understand and adapt to their context. This includes recognizing the identity of the user accessing the document, the device being used, the location of the access, and the stage of the document's lifecycle. For instance, a contract document may display different user interfaces depending on whether it is being accessed by the creator, a signatory, or a reviewer. Similarly, the document can adapt its behavior based on whether it is being accessed on a mobile device, desktop, or tablet.

Negotiation of Communication Protocols: Smart documents are capable of negotiating the manner in which they communicate with external systems. They can respond to requests using various protocols, such as RESTful APIs, gRPC, or even machine-specific languages like MCP (Machine Communication Protocol). This flexibility ensures that the document can seamlessly integrate with diverse systems and applications, making it highly interoperable.

Dynamic User Experience: The embedded intelligence enables smart documents to create personalized user experiences. For example, the document can present different panels, workflows, or visualizations depending on the user's role, the document's lifecycle stage, or the specific task being performed. This dynamic adaptability enhances usability and ensures that the document serves the needs of each stakeholder effectively.

Machine Learning and Predictive Capabilities: Smart documents can leverage machine learning algorithms to analyze their audit trail, content, and metadata to predict user needs or suggest actions. For instance, a smart document could identify patterns in user interactions and recommend next steps, such as suggesting additional documents that may be relevant to the current task or flagging anomalies in the audit trail for review.

### How Intelligence Is Embedded

The intelligence of smart documents is embedded through the integration of one or more components:

Executable Code: At the core of a smart document's intelligence is its embedded executable code. This code acts as the “brain” of the document, enabling it to process requests, perform actions, and interact with external systems. The code is designed to be lightweight and modular, allowing it to execute specific tasks efficiently without compromising the document's performance.

Metadata: Metadata provides the document with contextual information about itself, such as its creation date, owner, version history, and access permissions. This metadata is stored in a machine-readable format and is cryptographically secured to ensure its integrity. The document's intelligence uses this metadata to make decisions and respond to queries.

Machine-Readable Content: Unlike traditional documents, which are primarily human-readable, smart documents store their content in a machine-readable format. This allows the embedded intelligence to analyze the content, extract specific information, and perform operations based on the content's structure and meaning.

APIs for Interaction: Smart documents expose APIs (Application Programming Interfaces) that allow external systems to interact with them. These APIs enable the document to receive requests, process them, and return responses in a structured format, such as JSON or XML. The APIs also facilitate integration with other applications and systems, making the document highly interoperable.

Cryptographic Infrastructure: The intelligence of smart documents is underpinned by cryptographic infrastructure, which ensures the security and authenticity of the document's interactions. For example, digital signatures and hash-based identifiers are used to verify the integrity of the document and its audit trail, while encryption protects sensitive data.

Machine Learning Models: Machine learning models can be embedded within the document or accessed through external systems to enhance its intelligence. These models enable the document to analyze patterns, predict outcomes, and adapt its behavior based on historical data and real-time inputs.

### Examples of Embedded Intelligence in Action

Audit Trail Analysis: A smart document can analyze its audit trail to identify unusual patterns, such as repeated failed access attempts, and alert the owner to potential security risks.

Dynamic Rendering: When accessed on a mobile device, a smart document can automatically adjust its layout to optimize readability and usability, while providing additional features like touch-based navigation.

Workflow Management: A smart document associated with a workflow can track its progress and notify stakeholders of pending actions, such as signatures or approvals.

Content Extraction: A smart document can respond to a query by extracting specific information from its content, such as the total amount in an invoice or the number of items listed in a receipt.

Protocol Negotiation: A smart document can negotiate the format of its responses based on the preferences of the requesting system, such as providing data in JSON for web applications or XML for enterprise systems.

In summary, the embedded intelligence of smart documents is achieved through the integration of executable code, metadata, machine-readable content, APIs, cryptographic infrastructure, and machine learning models. This intelligence enables the document to interact dynamically with its environment, adapt to its context, and provide personalized experiences, making it a paradigm shift in document management.

The combination of immutability and embedded intelligence in smart documents creates a new paradigm for document management, offering unparalleled integrity, authenticity, traceability, and adaptability. Together, these features address longstanding challenges in document security, compliance, and usability, while enabling dynamic interactions and personalized experiences.

### The Synergy of Immutability and Embedded Intelligence

The combination of immutability and embedded intelligence creates a powerful synergy that revolutionizes document management. Immutability provides the foundation of trust, ensuring that the document's content and history are secure, authentic, and tamper-proof. Embedded intelligence builds on this foundation, enabling the document to interact dynamically with its environment, adapt to its context, and provide personalized experiences.

Enhanced Integrity and Authenticity: Immutability ensures that the document's content and audit trail remain unchanged, while embedded intelligence enables the document to verify its authenticity and respond to queries about its provenance. Together, these features create a system where trust is inherent and verifiable.

Dynamic Traceability: The immutable audit trail provides a complete history of interactions with the document, while embedded intelligence allows the document to analyze and interpret this history. This dynamic traceability enables stakeholders to understand not only what happened to the document but also why and how.

Personalized Compliance: Immutability simplifies regulatory compliance by providing a reliable and tamper-proof record of the document and its history. Embedded intelligence enhances this by adapting the document's behavior to meet specific compliance requirements, such as displaying relevant panels or workflows based on the user's role or jurisdiction.

Interoperability and Adaptability: The permanent global marker ensures seamless integration with external systems, while embedded intelligence enables the document to negotiate communication protocols and adapt its responses to different platforms. This combination ensures that the document can function effectively in diverse environments.

Predictive Security and Usability: Immutability protects the document from tampering, while embedded intelligence leverages machine learning to predict potential security risks and suggest preventive actions. This proactive approach enhances both security and usability, ensuring that the document serves the needs of its stakeholders effectively.

### Real-world Applications

The synergy of immutability and embedded intelligence has significant implications across industries:

Legal and Compliance: Smart contracts can ensure the integrity of agreements while dynamically adapting to regulatory changes.

Finance: Immutable audit trails and intelligent analysis can enhance fraud detection and streamline reporting.

Healthcare: Patient records can remain secure and authentic while providing personalized access to authorized stakeholders.

Supply Chain: Immutable tracking and intelligent analysis can optimize logistics and ensure product authenticity.

In summary, the combination of immutability and embedded intelligence in smart documents creates a revolutionary framework for document management. By ensuring integrity, authenticity, and traceability while enabling dynamic interactions and personalized experiences, this synergy addresses longstanding challenges and unlocks new possibilities for innovation and efficiency.

### Alternative Terminology

The term “smart document” or “smart electronic document” can also be referred to as a self-governing document, a self-tracking document, a self-assimilating document, a document with executable code, a document with embedded code, and/or in a variety of other ways depending on the context and on the features of the smart document. In any example, a smart electronic document includes three elements, at minimum—data (e.g., content, audit trail, other metadata, etc.), executable code (e.g., an API), and a globally unique marker.

By embedding access control mechanisms directly within the document, self-governing documents can provide a unified framework for managing permissions across both the document and its attachments. This can eliminate the need for external systems to enforce restrictions, reducing complexity and enhancing security. Access control for attachments also provides a comprehensive audit trail, recording all interactions with both the document and its associated content. This ensures accountability and transparency, making self-governing documents an effective solution for managing sensitive information in a secure and compliant manner.

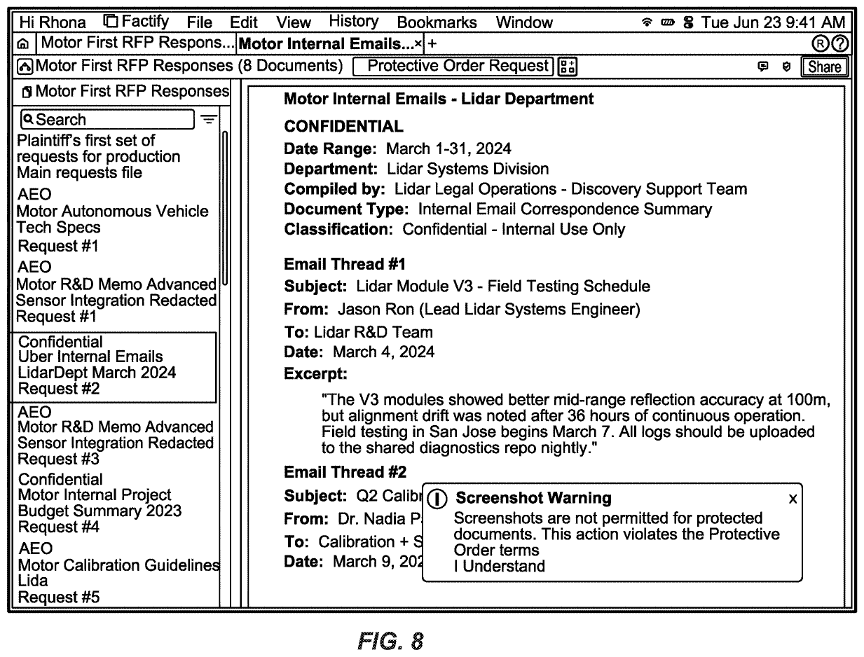

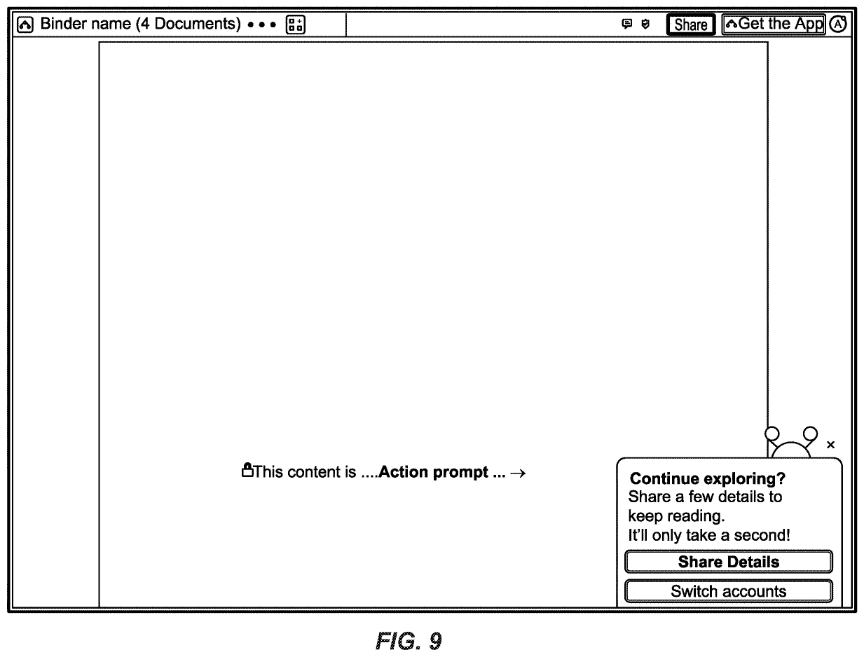

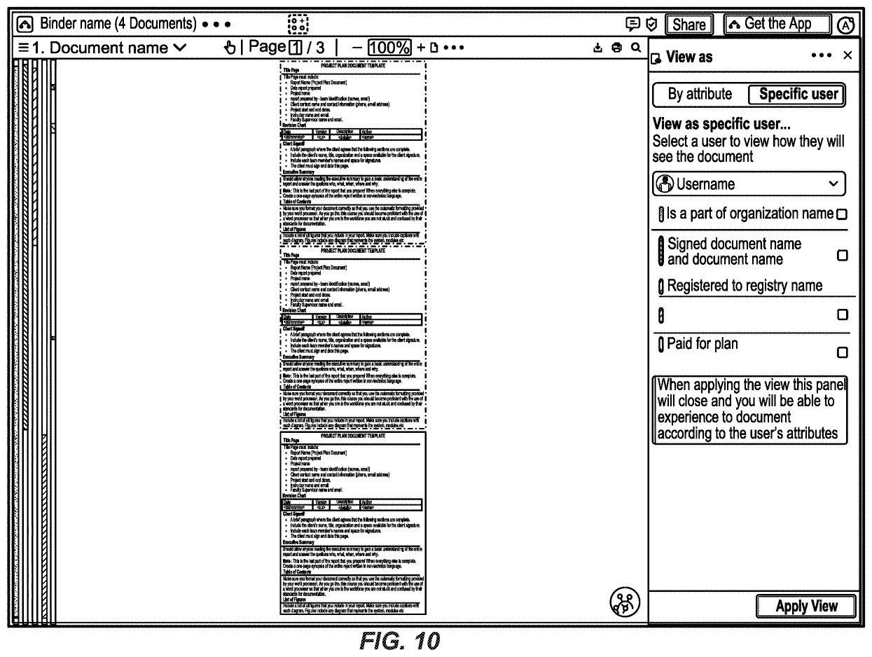

FIG. 8 illustrates a system designed to prevent unauthorized actions, such as screenshots, on protected documents. The figure depicts a user interface displaying a document that is classified as confidential and subject to a protective order. The system includes a warning mechanism that actively monitors user actions and provides real-time feedback when an unauthorized action is attempted. In this example, the system detects an attempt to take a screenshot of the document and immediately displays a warning message: “Screenshots are not permitted for protected documents. This action violates the Protective Order terms.” This notification ensures that users are aware of the restrictions and prevents the dissemination of sensitive information through unauthorized means. FIG. 9 illustrates an interface with action prompt, and FIG. 10 illustrates an example of enabling the capability to view as a specific user.

A self-governing document can be a technical solution to the critical problem of maintaining control, security, and traceability over digital documents, which are often vulnerable to unauthorized modifications, fragmented audit trails, and inefficient management. This advanced document structure features immutable content and an immutable audit trail, both immutably connected to an immutable global identifier, ensuring that the document's content, history, and identity remain tamper-proof and trustworthy. The machine-readable design of the self-governing document can allow seamless integration with computational systems, enabling automated processing, querying, and verification of its data and interactions.

Additionally, the self-governing document can incorporate intelligence in the form of embedded executable code, which enables it to be responsive and interactive. This embedded code allows the document to autonomously enforce access permissions, execute workflows, and respond dynamically to user or system queries, transforming it from a static file into a dynamic, self-regulating entity. By combining immutability, machine-readability, and embedded intelligence, the self-governing document provides a robust solution to the challenges of document security, operational efficiency, and traceability in modern digital ecosystems.

A self-governing document can address the problems of data security, inefficient use of device hardware, and inefficient use of network systems associated with traditional PDFs by leveraging its immutable structure, embedded intelligence, and machine-readable design. In terms of data security, the document's cryptographic commitments ensure that its content, audit trail, and global identifier remain tamper-proof and trustworthy, eliminating vulnerabilities inherent in PDFs, which often rely on external systems for encryption and access control. The embedded intelligence within the self-governing document autonomously enforces granular access permissions, dynamically adapting to user roles and security protocols, reducing the risk of unauthorized access and ensuring compliance with stringent security requirements.

Regarding device hardware, traditional PDFs require significant computational resources for rendering, extracting data, and managing versions, often leading to inefficiencies and hardware strain. A self-governing document, with its machine-readable format and embedded intelligence, can eliminate the need for complex text extraction algorithms and redundant processing, optimizing the use of device hardware and enabling faster, more efficient operations. Similarly, network systems that handle PDFs often experience bandwidth inefficiencies due to the need to transmit large, static files and duplicate versions. A self-governing document can address this by maintaining a single source of truth that is universally accessible via its global identifier, reducing the need to transmit entire files and instead enabling lightweight, API-driven interactions. This approach minimizes network bandwidth usage, streamlines workflows, and ensures that documents are securely and efficiently managed across devices and systems, making them ideal for modern digital ecosystems.

Aspects of this disclosure provide a technical solution to the technical problem of managing access to electronic documents in a secure and efficient manner, leveraging computing and network hardware to improve resource utilization and security in a manner that traditional systems cannot. Some examples provide a method where a self-governing document autonomously maintains records identifying entities authorized to access specific portions of the document. This approach addresses the challenge of ensuring document security and access control in a digital environment, where traditional methods often fall short due to reliance on external systems and manual processes.

The technical solution involves the use of computing hardware, such as processors and memory devices, to store and process access records within the document itself. By embedding intelligence within the document, the system reduces the need for external servers or databases to manage access control, thereby optimizing resource efficiency. The self-governing document can independently verify access requests using its internal records, minimizing network traffic and reducing the load on centralized systems. This decentralized approach can enhance the scalability of a system, allowing it to handle a large number of access requests without compromising performance.

Furthermore, the methods and systems described herein utilize network hardware to facilitate secure communication between the document and remote interfaces. By processing access requests locally within the document, the system can reduce the amount of data transmitted over the network, conserving bandwidth and improving response times. This efficient use of network resources is particularly beneficial in environments with limited connectivity or high traffic, where minimizing data exchange is crucial for maintaining system performance and connectivity.

Aspects of this disclosure provide a robust technical solution to the problem of document access management, leveraging computing and network hardware in efficient ways to enhance security, scalability, and resource utilization. By enabling self-governing documents to autonomously control access, the systems and methods described herein address the limitations of traditional document management methods, offering a more efficient and secure approach to handling digital information.

In conclusion, the systems and methods described in this disclosure address the pressing challenges of document security and access management in the digital age. By leveraging self-governing documents embedded with intelligence, the systems and methods provide a framework for autonomous control over document interactions, ensuring that only authorized entities can access sensitive information. The integrations described herein reduce reliance on external systems and enhance scalability. This decentralized approach not only conserves bandwidth and can improve response times, but also offers a more secure and effective solution to managing electronic documents. Through features such as tiered access, cryptographic watermarking, and dynamic interaction capabilities, self-governing documents empower document owners to maintain control and integrity over their digital assets, paving the way for new business opportunities and streamlined operations. As organizations continue to navigate the complexities of document management, aspects of this disclosure enable a forward-thinking strategy that aligns with evolving technological and security demands.
Clause 1. A method comprising: maintaining, by a self-governing document, records identifying entities authorized access to at least portions of the self-governing document; receiving, at the self-governing document, a request from a remote interface to access the self-governing document; using, by the self-governing document, the records to determine whether the request from the remote interface is from an authorized entity; and in response to determining whether the request is from an authorized entity, performing one of: providing a response to the remote interface indicating access to the self-governing document is allowed; and providing a response to the remote interface indicating access to the self-governing document is not allowed.
Clause 2. The method of clause 1, further comprising: identifying each entity with authorized access; and creating, based on identifying each entity with authorized access, the records identifying the authorized entities.
Clause 3. The method of clauses 1-2, further comprising: receiving, at the self-governing document, a request to revoke an access right of an entity allowed to access the document; and updating, by the self-governing document, the records identifying the entity to reflect the revoked access right.
Clause 4. The method of clauses 1-3, wherein: using, by the self-governing document, the records to determine whether the request from the remote interface is from an authorized entity comprises determining that the entity has a temporary right to access to the document; providing a response to the remote interface indicating access to the self-governing document is allowed comprises providing a response to the remote interface indicating access to the self-governing document is allowed for a predetermined period of time; and providing a response to the remote interface indicating access to the self-governing document is not allowed comprises providing a response to the remote interface indicating access to the self-governing document is not allowed beyond the predetermined period of time.
Clause 5. The method of clauses 1-4, wherein providing the response to the remote interface indicating access to the self-governing document is allowed comprises: providing encrypted data of the document to the remote interface; and indicating one of: that the encrypted data is allowed to be decrypted and displayed via the remote interface only while the remote interface maintains a network connection with the self-governing document; or that the encrypted data is allowed to be decrypted and displayed via the remote interface both while the remote interface maintains a network connection with the self-governing document and when the remote interface does not have a network connection to the self-governing document.
Clause 6. The method of clauses 1-5, wherein indicating that the encrypted data is allowed to be decrypted and displayed via the remote interface when the remote interface does not have a network connection to the self-governing document further comprises: determining that connection to the remote interface has been restored after a period of disconnection between the remote interface and the self-governing document; and in response to determining that the connection has been restored, reconciling at least one difference between data of the document stored locally via the remote interface and data stored at the self-governing document.
Clause 7. The method of clauses 1-6, wherein providing the response to the remote interface indicating access to the self-governing document is allowed comprises: providing data of the self-governing document to the remote interface; allowing the remote interface to display the data; and requiring the remote interface to display a cryptographic watermark while displaying the data.
Clause 8. The method of clauses 1-7, further comprising recording, by the self-governing document, information about the request to access the self-governing document.
Clause 9. The method of clauses 1-8, wherein: the request to access the self-governing document comprises a request to share the self-governing document; using, by the self-governing document, the records to determine whether the request from the remote interface is from the entity allowed to access the document comprises determining that the entity is allowed to share the document; and providing the response to the remote interface indicating access to the self-governing document is allowed comprises allowing the document to be shared.
Clause 10. The method of clauses 1-9, wherein determining that the entity is allowed to share the document comprises: determining that the entity is allowed to share the document a limited number of times; and determining that the entity has shared the document less than the limited number of times.
Clause 11. The method of clauses 1-10, wherein the request to access the self-governing document comprises a request to print the self-governing document; using, by the self-governing document, the records to determine whether the request from the remote interface is from the entity allowed to access the document comprises determining that the entity is allowed to print the document; and providing the response to the remote interface indicating access to the self-governing document is allowed comprises allowing the document to be printed via the remote interface.
Clause 12. The method of clauses 1-11, wherein using, by the self-governing document, the records to determine whether the request from the remote interface is from an authorized entity comprising using the records to determine that the authorized entity is allowed to access a subset of data within the self-governing document.
Clause 13. A system comprising: one or more physical processors; and physical memory comprising computer-executable instructions that, when executed by the one or more physical processors, cause at least one of the one or more physical processors to: maintain, by a self-governing document, records identifying entities authorized access to at least portions of the self-governing document; receive, at the self-governing document, a request from a remote interface to access the self-governing document; use, by the self-governing document, the records to determine whether the request from the remote interface is from an authorized entity; and in response to determining whether the request is from an authorized entity, perform one of: providing a response to the remote interface indicating access to the self-governing document is allowed; and providing a response to the remote interface indicating access to the self-governing document is not allowed.
Clause 14. The system of clause 13, the computer-executable instructions further cause the one or more physical processors to: identify each entity with authorized access; and create, based on identifying each entity with authorized access, the records identifying the authorized entities.
Clause 15. The system of clauses 13-14, wherein the computer-executable instructions further cause the one or more physical processors to: receive, at the self-governing document, a request to revoke an access right of an entity allowed to access the document; and update, by the self-governing document, the records identifying the entity to reflect the revoked access right.
Clause 16. The system of clauses 13-15, wherein: the computer-executable instructions cause the one or more physical processors to use, by the self-governing document, the records to determine whether the request from the remote interface is from an authorized entity by determining that the entity has a temporary right to access to the document; the computer-executable instructions cause the one or more physical processors to provide a response to the remote interface indicating access to the self-governing document is allowed by providing a response to the remote interface indicating access to the self-governing document is allowed for a predetermined period of time; and the computer-executable instructions cause the one or more physical processors to provide a response to the remote interface indicating access to the self-governing document is not allowed by providing a response to the remote interface indicating access to the self-governing document is not allowed beyond the predetermined period of time.
Clause 17. The system of clauses 13-16, wherein the computer-executable instructions cause the one or more physical processors to provide the response to the remote interface indicating access to the self-governing document is allowed by: providing encrypted data of the document to the remote interface; and indicating one of: that the encrypted data is allowed to be decrypted and displayed via the remote interface only while the remote interface maintains a network connection with the self-governing document; or that the encrypted data is allowed to be decrypted and displayed via the remote interface both while the remote interface maintains a network connection with the self-governing document and when the remote interface does not have a network connection to the self-governing document.
Clause 18. The system of clauses 13-17, wherein indicating that the encrypted data is allowed to be decrypted and displayed via the remote interface when the remote interface does not have a network connection to the self-governing document further comprises: determining that connection to the remote interface has been restored after a period of disconnection between the remote interface and the self-governing document; and in response to determining that the connection has been restored, reconciling at least one difference between data of the document stored locally via the remote interface and data stored at the self-governing document.
Clause 19. The system of clauses 13-18, wherein the computer-executable instructions cause the one or more physical processors to provide the response to the remote interface indicating access to the self-governing document is allowed by: providing data of the self-governing document to the remote interface; allowing the remote interface to display the data; and requiring the remote interface to display a cryptographic watermark while displaying the data.
Clause 20. The system of clauses 13-19, wherein the computer-executable instructions further cause the one or more physical processors to record, by the self-governing document, information about the request to access the self-governing document.
Clause 21. The system of clauses 13-20, wherein: the request to access the self-governing document comprises a request to share the self-governing document; the computer-executable instructions cause the one or more physical processors to use, by the self-governing document, the records to determine whether the request from the remote interface is from the entity allowed to access the document by determining that the entity is allowed to share the document; and the computer-executable instructions cause the one or more physical processors to provide the response to the remote interface indicating access to the self-governing document is allowed by allowing the document to be shared.
Clause 22. The system of clauses 13-21, wherein the computer-executable instructions cause the one or more physical processors to determine that the entity is allowed to share the document by: determining that the entity is allowed to share the document a limited number of times; and determining that the entity has shared the document less than the limited number of times.
Clause 23. The system of clauses 13-22, wherein the request to access the self-governing document comprises a request to print the self-governing document; the computer-executable instructions cause the one or more physical processors to use, by the self-governing document, the records to determine whether the request from the remote interface is from the entity allowed to access the document by determining that the entity is allowed to print the document; and the computer-executable instructions cause the one or more physical processors to provide the response to the remote interface indicating access to the self-governing document is allowed by allowing the document to be printed via the remote interface.
Clause 24. The system of clauses 13-23, wherein the computer-executable instructions cause the one or more physical processors to use, by the self-governing document, the records to determine whether the request from the remote interface is from an authorized entity by using the records to determine that the authorized entity is allowed to access a subset of data within the self-governing document.
Clause 25. A non-transitory computer-readable medium comprising computer-executable instructions that, when executed by at least one of one or more physical processors of a computing device, cause the computing device to: maintain, by a self-governing document, records identifying entities authorized access to at least portions of the self-governing document; receive, at the self-governing document, a request from a remote interface to access the self-governing document; use, by the self-governing document, the records to determine whether the request from the remote interface is from an authorized entity; and in response to determining whether the request is from an authorized entity, perform one of: providing a response to the remote interface indicating access to the self-governing document is allowed; and providing a response to the remote interface indicating access to the self-governing document is not allowed.
Clause 26. The non-transitory computer-readable medium of clause 25, wherein the computer-executable instructions further cause the one or more physical processors to: identify each entity with authorized access; and create, based on identifying each entity with authorized access, the records identifying the authorized entities.
Clause 27. The non-transitory computer-readable medium of clauses 25-26, wherein the computer-executable instructions further cause the one or more physical processors to: receive, at the self-governing document, a request to revoke an access right of an entity allowed to access the document; and update, by the self-governing document, the records identifying the entity to reflect the revoked access right.
Clause 28. The non-transitory computer-readable medium of clauses 25-27, wherein: the computer-executable instructions cause the one or more physical processors to use, by the self-governing document, the records to determine whether the request from the remote interface is from an authorized entity by determining that the entity has a temporary right to access to the document; the computer-executable instructions cause the one or more physical processors to provide a response to the remote interface indicating access to the self-governing document is allowed by providing a response to the remote interface indicating access to the self-governing document is allowed for a predetermined period of time; and the computer-executable instructions cause the one or more physical processors to provide a response to the remote interface indicating access to the self-governing document is not allowed by providing a response to the remote interface indicating access to the self-governing document is not allowed beyond the predetermined period of time.
Clause 29. The non-transitory computer-readable medium of clauses 25-28, wherein the computer-executable instructions cause the one or more physical processors to provide the response to the remote interface indicating access to the self-governing document is allowed by: providing encrypted data of the document to the remote interface; and indicating one of: that the encrypted data is allowed to be decrypted and displayed via the remote interface only while the remote interface maintains a network connection with the self-governing document; or that the encrypted data is allowed to be decrypted and displayed via the remote interface both while the remote interface maintains a network connection with the self-governing document and when the remote interface does not have a network connection to the self-governing document.
Clause 30. The non-transitory computer-readable medium of clause 25-29, wherein indicating that the encrypted data is allowed to be decrypted and displayed via the remote interface when the remote interface does not have a network connection to the self-governing document further comprises: determining that connection to the remote interface has been restored after a period of disconnection between the remote interface and the self-governing document; and in response to determining that the connection has been restored, reconciling at least one difference between data of the document stored locally via the remote interface and data stored at the self-governing document.
Clause 31. The non-transitory computer-readable medium of clauses 25-30, wherein the computer-executable instructions cause the one or more physical processors to provide the response to the remote interface indicating access to the self-governing document is allowed by: providing data of the self-governing document to the remote interface; allowing the remote interface to display the data; and requiring the remote interface to display a cryptographic watermark while displaying the data.
Clause 32. The non-transitory computer-readable medium of clauses 25-31, wherein the computer-executable instructions further cause the one or more physical processors to record, by the self-governing document, information about the request to access the self-governing document.
Clause 33. The non-transitory computer-readable medium of clauses 25-32, wherein: the request to access the self-governing document comprises a request to share the self-governing document; the computer-executable instructions cause the one or more physical processors to use, by the self-governing document, the records to determine whether the request from the remote interface is from the entity allowed to access the document by determining that the entity is allowed to share the document; and the computer-executable instructions cause the one or more physical processors to provide the response to the remote interface indicating access to the self-governing document is allowed by allowing the document to be shared.
Clause 34. The non-transitory computer-readable medium of clauses 25-33, wherein the computer-executable instructions cause the one or more physical processors to determine that the entity is allowed to share the document by: determining that the entity is allowed to share the document a limited number of times; and determining that the entity has shared the document less than the limited number of times.
Clause 35. The non-transitory computer-readable medium of clauses 25-34, wherein: the request to access the self-governing document comprises a request to print the self-governing document; the computer-executable instructions cause the one or more physical processors to use, by the self-governing document, the records to determine whether the request from the remote interface is from the entity allowed to access the document by determining that the entity is allowed to print the document; and the computer-executable instructions cause the one or more physical processors to provide the response to the remote interface indicating access to the self-governing document is allowed by allowing the document to be printed via the remote interface.
Clause 36. The non-transitory computer-readable medium of clauses 25-35, wherein the computer-executable instructions cause the one or more physical processors to use, by the self-governing document, the records to determine whether the request from the remote interface is from an authorized entity by using the records to determine that the authorized entity is allowed to access a subset of data within the self-governing document.

The features and clauses discussed herein may provide one or more of the advantages and/or solutions described, such as enhancing security, improving operational efficiency, or enabling dynamic access control. Additionally, these features and clauses may offer further or alternative benefits or address further or alternative challenges beyond those explicitly mentioned. The disclosed features and clauses are not limited to the specific advantages or solutions described and may be implemented in various ways to achieve additional or alternative benefits and/or solutions.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
maintaining, by a self-governing document, records identifying entities authorized access to at least portions of the self-governing document;
receiving, at the self-governing document, a request from a remote interface to access the self-governing document;
using, by the self-governing document, the records to determine whether the request from the remote interface is from an authorized entity; and
in response to determining whether the request is from an authorized entity, performing one of:
providing a response to the remote interface indicating access to the self-governing document is allowed; and
providing a response to the remote interface indicating access to the self-governing document is not allowed.

2. The method of claim 1, further comprising:
identifying each entity with authorized access; and
creating, based on identifying each entity with authorized access, the records identifying the authorized entities.

3. The method of claim 1, further comprising:
receiving, at the self-governing document, a request to revoke an access right of an entity allowed to access the document; and
updating, by the self-governing document, the records identifying the entity to reflect the revoked access right.

4. The method of claim 1, wherein:
using, by the self-governing document, the records to determine whether the request from the remote interface is from an authorized entity comprises determining that the entity has a temporary right to access to the document;
providing a response to the remote interface indicating access to the self-governing document is allowed comprises providing a response to the remote interface indicating access to the self-governing document is allowed for a predetermined period of time; and
providing a response to the remote interface indicating access to the self-governing document is not allowed comprises providing a response to the remote interface indicating access to the self-governing document is not allowed beyond the predetermined period of time.

5. The method of claim 1, wherein providing the response to the remote interface indicating access to the self-governing document is allowed comprises:
providing encrypted data of the document to the remote interface; and
indicating one of:
that the encrypted data is allowed to be decrypted and displayed via the remote interface only while the remote interface maintains a network connection with the self-governing document; or
that the encrypted data is allowed to be decrypted and displayed via the remote interface both while the remote interface maintains a network connection with the self-governing document and when the remote interface does not have a network connection to the self-governing document.

6. The method of claim 5, wherein indicating that the encrypted data is allowed to be decrypted and displayed via the remote interface when the remote interface does not have a network connection to the self-governing document further comprises:
determining that connection to the remote interface has been restored after a period of disconnection between the remote interface and the self-governing document; and
in response to determining that the connection has been restored, reconciling at least one difference between data of the document stored locally via the remote interface and data stored at the self-governing document.

7. The method of claim 1, wherein providing the response to the remote interface indicating access to the self-governing document is allowed comprises:
providing data of the self-governing document to the remote interface;
allowing the remote interface to display the data; and
requiring the remote interface to display a cryptographic watermark while displaying the data.

8. The method of claim 1, further comprising recording, by the self-governing document, information about the request to access the self-governing document.

9. The method of claim 1, wherein:
the request to access the self-governing document comprises a request to share the self-governing document;
using, by the self-governing document, the records to determine whether the request from the remote interface is from the entity allowed to access the document comprises determining that the entity is allowed to share the document; and
providing the response to the remote interface indicating access to the self-governing document is allowed comprises allowing the document to be shared.

10. The method of claim 9, wherein determining that the entity is allowed to share the document comprises:
determining that the entity is allowed to share the document a limited number of times; and
determining that the entity has shared the document less than the limited number of times.

11. The method of claim 1, wherein
the request to access the self-governing document comprises a request to print the self-governing document;
using, by the self-governing document, the records to determine whether the request from the remote interface is from the entity allowed to access the document comprises determining that the entity is allowed to print the document; and
providing the response to the remote interface indicating access to the self-governing document is allowed comprises allowing the document to be printed via the remote interface.

12. The method of claim 1, wherein using, by the self-governing document, the records to determine whether the request from the remote interface is from an authorized entity comprises using the records to determine that the authorized entity is allowed to access a subset of data within the self-governing document.

13. The method of claim 1, wherein the self-governing document is embedded with intelligence that performs the maintain, receiving, using, and providing steps and that enables the self-governing document to operate independently within a digital ecosystem.

14. The method of claim 1, wherein the self-governing document uses the records to determine whether the request from the remote interface is from an authorized entity via a machine learning technique.

15. The method of claim 1, wherein the self-governing document is configured to ensure that an artificial intelligence agent can interact only with the content relevant to tasks of the artificial intelligence agent in a manner that reduces the risk of unauthorized data exposure.

16. The method of claim 1, wherein the self-governing document is configured to manage artificial intelligence agent access to the self-governing document by autonomously evaluating permissions for one or more specific portions of the self-governing document.

17. The method of claim 1, wherein the self-governing document is configured to maintain an audit trail for interactions between artificial intelligence agents and the self-governing document by recording which agents accessed which portions of the self-governing document and for what purpose.

18. A system comprising:
one or more physical processors; and
physical memory comprising computer-executable instructions that, when executed by the one or more physical processors, cause at least one of the one or more physical processors to:
maintain, by a self-governing document, records identifying entities authorized access to at least portions of the self-governing document;
receive, at the self-governing document, a request from a remote interface to access the self-governing document;
use, by the self-governing document, the records to determine whether the request from the remote interface is from an authorized entity; and
in response to determining whether the request is from an authorized entity, perform one of:
providing a response to the remote interface indicating access to the self-governing document is allowed; and
providing a response to the remote interface indicating access to the self-governing document is not allowed.

19. The system of claim 18, the computer-executable instructions further cause the one or more physical processors to:
identify each entity with authorized access; and
create, based on identifying each entity with authorized access, the records identifying the authorized entities.

20. The system of claim 18, wherein the computer-executable instructions further cause the one or more physical processors to:
receive, at the self-governing document, a request to revoke an access right of an entity allowed to access the document; and
update, by the self-governing document, the records identifying the entity to reflect the revoked access right.

21. The system of claim 18, wherein:
the computer-executable instructions cause the one or more physical processors to use, by the self-governing document, the records to determine whether the request from the remote interface is from an authorized entity by determining that the entity has a temporary right to access to the document;
the computer-executable instructions cause the one or more physical processors to provide a response to the remote interface indicating access to the self-governing document is allowed by providing a response to the remote interface indicating access to the self-governing document is allowed for a predetermined period of time; and
the computer-executable instructions cause the one or more physical processors to provide a response to the remote interface indicating access to the self-governing document is not allowed by providing a response to the remote interface indicating access to the self-governing document is not allowed beyond the predetermined period of time.

22. The system of claim 18, wherein the computer-executable instructions cause the one or more physical processors to provide the response to the remote interface indicating access to the self-governing document is allowed by:
providing encrypted data of the document to the remote interface; and
indicating one of:
that the encrypted data is allowed to be decrypted and displayed via the remote interface only while the remote interface maintains a network connection with the self-governing document; or
that the encrypted data is allowed to be decrypted and displayed via the remote interface both while the remote interface maintains a network connection with the self-governing document and when the remote interface does not have a network connection to the self-governing document.

23. The system of claim 22, wherein indicating that the encrypted data is allowed to be decrypted and displayed via the remote interface when the remote interface does not have a network connection to the self-governing document further comprises:
determining that connection to the remote interface has been restored after a period of disconnection between the remote interface and the self-governing document; and
in response to determining that the connection has been restored, reconciling at least one difference between data of the document stored locally via the remote interface and data stored at the self-governing document.

24. The system of claim 18, wherein the computer-executable instructions cause the one or more physical processors to provide the response to the remote interface indicating access to the self-governing document is allowed by:
providing data of the self-governing document to the remote interface;
allowing the remote interface to display the data; and
requiring the remote interface to display a cryptographic watermark while displaying the data.

25. The system of claim 18, wherein the computer-executable instructions further cause the one or more physical processors to record, by the self-governing document, information about the request to access the self-governing document.

26. The system of claim 18, wherein:
the request to access the self-governing document comprises a request to share the self-governing document;
the computer-executable instructions cause the one or more physical processors to use, by the self-governing document, the records to determine whether the request from the remote interface is from the entity allowed to access the document by determining that the entity is allowed to share the document; and
the computer-executable instructions cause the one or more physical processors to provide the response to the remote interface indicating access to the self-governing document is allowed by allowing the document to be shared.

27. The system of claim 26, wherein the computer-executable instructions cause the one or more physical processors to determine that the entity is allowed to share the document by:
determining that the entity is allowed to share the document a limited number of times; and
determining that the entity has shared the document less than the limited number of times.

28. The system of claim 18, wherein
the request to access the self-governing document comprises a request to print the self-governing document;
the computer-executable instructions cause the one or more physical processors to use, by the self-governing document, the records to determine whether the request from the remote interface is from the entity allowed to access the document by determining that the entity is allowed to print the document; and
the computer-executable instructions cause the one or more physical processors to provide the response to the remote interface indicating access to the self-governing document is allowed by allowing the document to be printed via the remote interface.

29. The system of claim 18, wherein the computer-executable instructions cause the one or more physical processors to use, by the self-governing document, the records to determine whether the request from the remote interface is from an authorized entity by using the records to determine that the authorized entity is allowed to access a subset of data within the self-governing document.

30. A non-transitory computer-readable medium comprising computer-executable instructions that, when executed by at least one of one or more physical processors of a computing device, cause the computing device to:
maintain, by a self-governing document, records identifying entities authorized access to at least portions of the self-governing document;
receive, at the self-governing document, a request from a remote interface to access the self-governing document;
use, by the self-governing document, the records to determine whether the request from the remote interface is from an authorized entity; and
in response to determining whether the request is from an authorized entity, perform one of:
providing a response to the remote interface indicating access to the self-governing document is allowed; and
providing a response to the remote interface indicating access to the self-governing document is not allowed.

31. The non-transitory computer-readable medium of claim 30, wherein the computer-executable instructions further cause the one or more physical processors to:
identify each entity with authorized access; and
create, based on identifying each entity with authorized access, the records identifying the authorized entities.

32. The non-transitory computer-readable medium of claim 30, wherein the computer-executable instructions further cause the one or more physical processors to:
receive, at the self-governing document, a request to revoke an access right of an entity allowed to access the document; and
update, by the self-governing document, the records identifying the entity to reflect the revoked access right.

33. The non-transitory computer-readable medium of claim 30, wherein:
the computer-executable instructions cause the one or more physical processors to use, by the self-governing document, the records to determine whether the request from the remote interface is from an authorized entity by determining that the entity has a temporary right to access to the document;
the computer-executable instructions cause the one or more physical processors to provide a response to the remote interface indicating access to the self-governing document is allowed by providing a response to the remote interface indicating access to the self-governing document is allowed for a predetermined period of time; and
the computer-executable instructions cause the one or more physical processors to provide a response to the remote interface indicating access to the self-governing document is not allowed by providing a response to the remote interface indicating access to the self-governing document is not allowed beyond the predetermined period of time.

34. The non-transitory computer-readable medium of claim 30, wherein the computer-executable instructions cause the one or more physical processors to provide the response to the remote interface indicating access to the self-governing document is allowed by:
providing encrypted data of the document to the remote interface; and
indicating one of:
that the encrypted data is allowed to be decrypted and displayed via the remote interface only while the remote interface maintains a network connection with the self-governing document; or
that the encrypted data is allowed to be decrypted and displayed via the remote interface both while the remote interface maintains a network connection with the self-governing document and when the remote interface does not have a network connection to the self-governing document.

35. The non-transitory computer-readable medium of claim 34, wherein indicating that the encrypted data is allowed to be decrypted and displayed via the remote interface when the remote interface does not have a network connection to the self-governing document further comprises:
determining that connection to the remote interface has been restored after a period of disconnection between the remote interface and the self-governing document; and
in response to determining that the connection has been restored, reconciling at least one difference between data of the document stored locally via the remote interface and data stored at the self-governing document.

36. The non-transitory computer-readable medium of claim 30, wherein the computer-executable instructions cause the one or more physical processors to provide the response to the remote interface indicating access to the self-governing document is allowed by:
providing data of the self-governing document to the remote interface;
allowing the remote interface to display the data; and
requiring the remote interface to display a cryptographic watermark while displaying the data.

37. The non-transitory computer-readable medium of claim 30, wherein the computer-executable instructions further cause the one or more physical processors to record, by the self-governing document, information about the request to access the self-governing document.

38. The non-transitory computer-readable medium of claim 30, wherein:
the request to access the self-governing document comprises a request to share the self-governing document;
the computer-executable instructions cause the one or more physical processors to use, by the self-governing document, the records to determine whether the request from the remote interface is from the entity allowed to access the document by determining that the entity is allowed to share the document; and
the computer-executable instructions cause the one or more physical processors to provide the response to the remote interface indicating access to the self-governing document is allowed by allowing the document to be shared.

39. The non-transitory computer-readable medium of claim 38, wherein the computer-executable instructions cause the one or more physical processors to determine that the entity is allowed to share the document by:
determining that the entity is allowed to share the document a limited number of times; and
determining that the entity has shared the document less than the limited number of times.

40. The non-transitory computer-readable medium of claim 30, wherein:
the request to access the self-governing document comprises a request to print the self-governing document;
the computer-executable instructions cause the one or more physical processors to use, by the self-governing document, the records to determine whether the request from the remote interface is from the entity allowed to access the document by determining that the entity is allowed to print the document; and
the computer-executable instructions cause the one or more physical processors to provide the response to the remote interface indicating access to the self-governing document is allowed by allowing the document to be printed via the remote interface.

41. The non-transitory computer-readable medium of claim 30, wherein the computer-executable instructions cause the one or more physical processors to use, by the self-governing document, the records to determine whether the request from the remote interface is from an authorized entity by using the records to determine that the authorized entity is allowed to access a subset of data within the self-governing document.
